(19) United States
(12) Patent Application Publication
(10) Pub. No.: US 2026/0149494 A1
(43) Pub. Date: May 28, 2026

(54) ELECTRONIC DEVICE FOR ACTIVATING DIVERSITY TX MODE AND METHOD FOR THE SAME

(71) Applicant: Samsung Electronics Co., Ltd., Suwon-si (KR)

(72) Inventors: Hyunkee MIN, Suwon-si (KR); Wonbin PARK, Suwon-si (KR); Sujeong BAEK, Suwon-si (KR); Minsoo KIM, Suwon-si (KR); Seonghwan KIM, Suwon-si (KR); Eonji LEE, Suwon-si (KR); Junghwi JEON, Suwon-si (KR); Boyoung CHOI, Suwon-si (KR)

(21) Appl. No.: 19/403,539

(22) Filed: Nov. 28, 2025

Related U.S. Application Data
(63) Continuation of application No. PCT/KR2025/019572, filed on Nov. 24, 2025.

(30) Foreign Application Priority Data
Nov. 28, 2024 (KR) 10-2024-0173595
Jan. 8, 2025 (KR) 10-2025-0003050

(51) Int. Cl. H04B 7/06; H04B 7/0404; H04W 88/06

(52) U.S. Cl. CPC H04B 7/0689; H04B 7/0404; H04W 88/06

(57) ABSTRACT

In an electronic device and a method of operating the electronic device, the electronic device may include: a housing including a first housing and a second housing foldable or movable with respect to each other; a plurality of antennas; communication circuitry supporting short-range wireless communication; a memory storing at least one computer program containing instructions; and at least one processor, comprising processing circuitry, wherein the instructions, when executed individually or collectively by at least one processor, may cause the electronic device to: perform short-range wireless communication with an external electronic device; control the communication circuitry to activate a diversity transmission mode configured to output signals containing the same data through each of the plural antennas based at least in part on the quality of the signal received from the external electronic device being less than or equal to a first value, based on the angle between the first housing structure and the second housing structure being less than a designated size; and control the communication circuitry to activate the diversity transmission mode based at least in part on the quality of the signal received from the external electronic device being less than a second value, based on the angle between the first housing and the second housing being greater than or equal to a designated size, and the first value is greater than the second value.

### CROSS-REFERENCE TO RELATED APPLICATIONS

This application is a continuation of International Application No. PCT/KR2025/019572 designating the United States, filed on Nov. 24, 2025, in the Korean Intellectual Property Receiving Office and claiming priority to Korean Patent Application Nos. 10-2024-0173595, filed on Nov. 28, 2024, and 10-2025-0003050, filed on Jan. 8, 2025, in the Korean Intellectual Property Office, the disclosures of each of which are incorporated by reference herein in their entireties.

### BACKGROUND

Field

The disclosure relates to an electronic device and a method of operating the electronic device, and for example, to an electronic device that activates a diversity transmission mode.

### Description of Related Art

With the spread of various electronic devices, improvements in wireless communication speed for these devices have been implemented. Among the wireless communications supported by recent electronic devices, IEEE 802.11 WLAN (or Wi-Fi) is a standard for implementing high-speed wireless connections on various electronic devices. The first implementation of Wi-Fi could support a maximum transmission speed of 1 to 9 Mbps, but Wi-Fi 6 technology (or IEEE 802.11ax) can support transmission speeds of up to about 10 Gbps.

Electronic devices can support various services (e.g., UHD quality video streaming services, augmented reality (AR) services, virtual reality (VR) services, or mixed reality (MR) services) using relatively large data capacity through wireless communication that supports high transmission speeds. Especially, recently various services related to transportation (e.g., navigation service, or content provision service) can be performed by being connected through the infotainment system implemented inside the vehicle and short-range wireless communication.

Electronic devices may support various signal transmission modes depending on the quality of the short-range wireless communication channel. For example, electronic devices can support a diversity transmission mode, which transmits signals containing the same data through each of plurality of antennas, and a spatial multiplexing mode, which transmits signals containing different data through each of plurality of antennas. The spatial multiplexing mode can achieve high transmission speeds by transmitting signals containing different parts of the data, while the diversity transmission mode may improve transmission success rates by transmitting signals containing the same data.

The electronic device can switch to a diversity transmission mode to improve the signal transmission success rate through short-range wireless communication. In the case that the quality of the signal received from an external electronic device connected through short-range wireless communication is less than or equal to a designated level, the electronic device can activate a diversity transmission mode and improve the transmission success rate by transmitting multiple signals containing the same data to the external electronic device.

However, the designated level may be a predefined value regardless of the state of the electronic device. The electronic device may not switch to diversity transmission mode when the signal strength received from the external electronic device is greater than or equal to a designated level in states (e.g., when the electronic device is implemented in a foldable housing, the angle between the housings is less than (or less than or equal to) a designated size, or a mode that reduces the signal strength output by the electronic device is activated) where the switch to diversity transmission mode must be performed quickly, and after detecting that the signal strength is less than (or less than or equal to) a designated level, the electronic device may switch to the diversity transmission mode. Delay in switching to the diversity transmission mode may cause a degradation in the performance of short-range wireless communication.

### SUMMARY

An electronic device according to an example embodiment may comprise: a housing including a first housing and a second housing foldable or movable with respect to each other; a plurality of antennas; communication circuitry configured to support short-range wireless communication; a memory storing at least one computer program containing instructions at least one processor, comprising processing circuitry, wherein at least one processor, individually or collectively, may be configured to execute the instructions and to cause the electronic device to: perform short-range wireless communication with an external electronic device; based on an angle between the first housing and the second housing being less than a designated size, control the communication circuitry to activate a diversity transmission mode configured to output signals containing the same data through each of the plural antennas, based at least in part on a quality of the signal received from the external electronic device being less than or equal to a first value; and based on the angle between the first housing and the second housing being greater than or equal to a designated size, control the communication circuitry to activate the diversity transmission mode based at least in part on the quality of the signal received from the external electronic device being less than a second value, wherein the first value may be greater than the second value.

According to an example embodiment, in a non-transitory computer-readable recording medium storing at least one program comprising instructions that when executed by at least one processor, comprising processing circuitry, of an electronic device, individually or collectively, cause the electronic device to: perform short-range wireless communication with an external electronic device; based on an angle between a first housing of the electronic device and a second housing of the electronic device being less than a designated size, control the communication circuitry to activate a diversity transmission mode configured to output signals containing the same data through each of the plural antennas, based at least in part on a quality of the signal received from the external electronic device being less than a first value; based on the angle between the first housing and the second housing being greater than or equal to a designated size, control the communication circuitry to activate the diversity transmission mode based at least in part on the quality of the signal received from the external electronic device being less than a second value, wherein the first value may be greater than the second value.

According to an example embodiment, a method of operating an electronic device comprising a housing including a first housing and a second housing foldable or movable with respect to each other may include: performing short-range wireless communication with an external electronic device; based on an angle between a first housing and a second housing being less than a designated size, controlling the communication circuitry of the electronic device to activate a diversity transmission mode configured to output signals containing the same data through each of the plural antennas, based at least in part on a quality of the signal received from the external electronic device being less than a first value; and based on the angle between the first housing and the second housing being greater than or equal to a designated size, controlling the communication circuitry to activate the diversity transmission mode, based at least in part on the quality of the signal received from the external electronic device being less than a second value, wherein the first value may be greater than the second value.

An electronic device according to an example embodiment may include: a plurality of antennas; communication circuitry configured to support short-range wireless communication; a memory storing at least one computer program containing instructions; at least one processor, comprising processing circuitry, individually or collectively, may be configured to execute the instructions to cause the electronic device to: perform short-range wireless communication with an external electronic device; based on the electronic device satisfying a designated condition, control the communication circuitry to activate a diversity transmission mode configured to output signals containing the same data through each of the plural antennas, based at least in part on a quality of the signal received from the external electronic device being less than a first value; and based on the electronic device not satisfying the designated condition, control the communication circuitry to activate the diversity transmission mode, based at least in part on the quality of the signal received from the external electronic device being less than a second value, wherein the first value may be configured to be greater than the second value.

The electronic device and the method of operating the electronic device according to various example embodiments may determine whether to activate the diversity transmission mode based on whether the quality of a signal received from an external electronic device is less than a value configured differently depending on whether the electronic device satisfies designated conditions. For example, the electronic device may identify whether the quality of the signal is less than (or less than or equal to) a first value when the angle between the first housing structure and the second housing structure is less than (or less than or equal to) a designated size, and may activate the diversity transmission mode in the case that the quality of the signal is less than (or less than or equal to) the first value. The electronic device may identify whether the quality of the signal is less than (or less than or equal to) a second value configured to be greater than the first value when the angle between the first housing structure and the second housing structure is greater than or equal to a designated size, and may activate the diversity transmission mode in the case that the quality of the signal is less than (or less than or equal to) the second value. The electronic device may improve the transmission success rate and quality of short-range wireless communication by rapidly activating the diversity transmission mode when its activation is required.

The effects obtainable from the disclosure are not limited to the effects mentioned above, and other effects that are not mentioned can be clearly understood by one skilled in the art to which the present disclosure pertains from the description below.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments;

FIG. 2A is a diagram illustrating an unfolded state of an example electronic device including a foldable housing according to various embodiments;

FIG. 2B is a diagram illustrating a folded state of an example electronic device including a foldable housing according to various embodiments;

FIG. 3A is a diagram illustrating the front surface of an example electronic device in a slide-in state of the electronic device including a rollable housing according to various embodiments;

FIG. 3B is a diagram illustrating the rear surface of an example electronic device in a slide-in state of the electronic device including a rollable housing according to various embodiments;

FIG. 3C is a diagram illustrating the front surface of an example electronic device in a slide-out state including a rollable housing according to various embodiments;

FIG. 3D is a diagram illustrating the rear surface of an example electronic device in a slide-out state including a rollable housing according to various embodiments;

FIG. 4 is a diagram illustrating an antenna and at least one component in an electronic device according to various embodiments;

FIG. 5 is a block diagram illustrating an example configuration of an electronic device according to various embodiments;

FIGS. 6A, 6B, and 6C are diagrams illustrating examples of an electronic device determining whether to activate a diversity transmission mode based on the angle between a first housing and a second housing according to various embodiments;

FIG. 7 is a diagram illustrating an example of an electronic device determining whether to activate a diversity transmission mode based on the length between the first housing and the second housing according to various embodiments;

FIG. 8 is a flowchart illustrating an example operation of an electronic device for determining whether to activate a diversity transmission mode based on the angle between the first housing and the second housing according to various embodiments;

FIG. 9 is a flowchart illustrating an example operation of an electronic device for determining whether to activate a diversity transmission mode based on whether the mode that reduces the output of the signal through short-range wireless communication (Tx backoff mode) is activated according to various embodiments;

FIG. 10 is a flowchart illustrating an example operation of an electronic device for determining whether to activate a diversity transmission mode based on whether the electronic device and the external electronic device is in LoS according to various embodiments;

FIG. 11 is a flowchart illustrating an example operation of an electronic device for determining whether to activate a diversity transmission mode based on the comparison result of the expected throughput and the currently measured throughput when the electronic device operates in a diversity transmission mode according to various embodiments; and

FIG. 12 is a flowchart illustrating an example method of operating an electronic device according to various embodiments.

### DETAILED DESCRIPTION

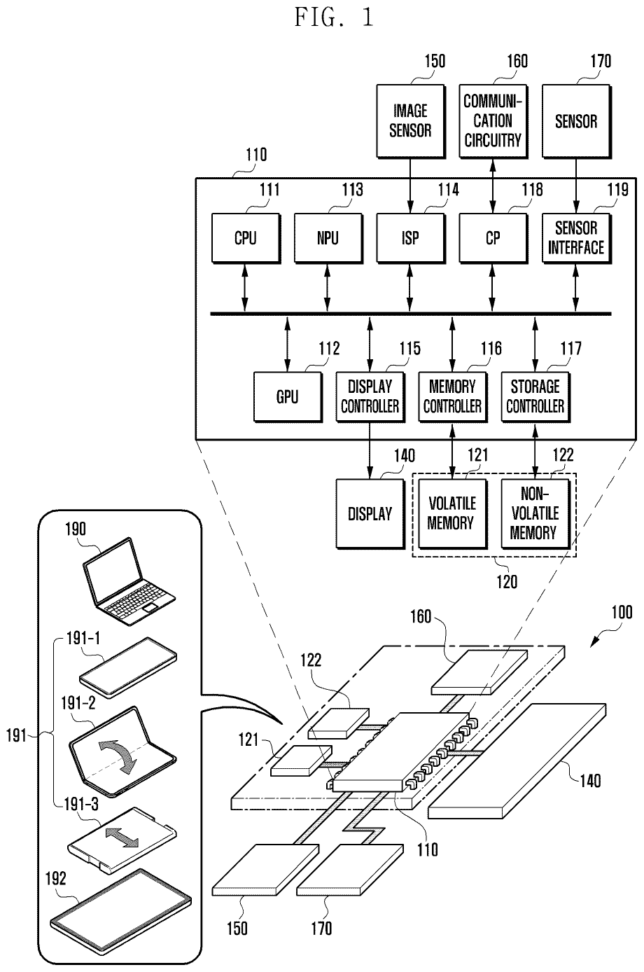

FIG. 1 is a block diagram illustrating an example configuration of an electronic device 100 capable of performing the operations described herein according to various embodiments.

With reference to FIG. 1, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone (not shown), and any other similar computing devices (not shown). The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor (e.g., including processing circuitry) 110 (hereinafter, the processor 110), at least one memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may include various processing circuitry and be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the present disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110. Thus, the processor, 110 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

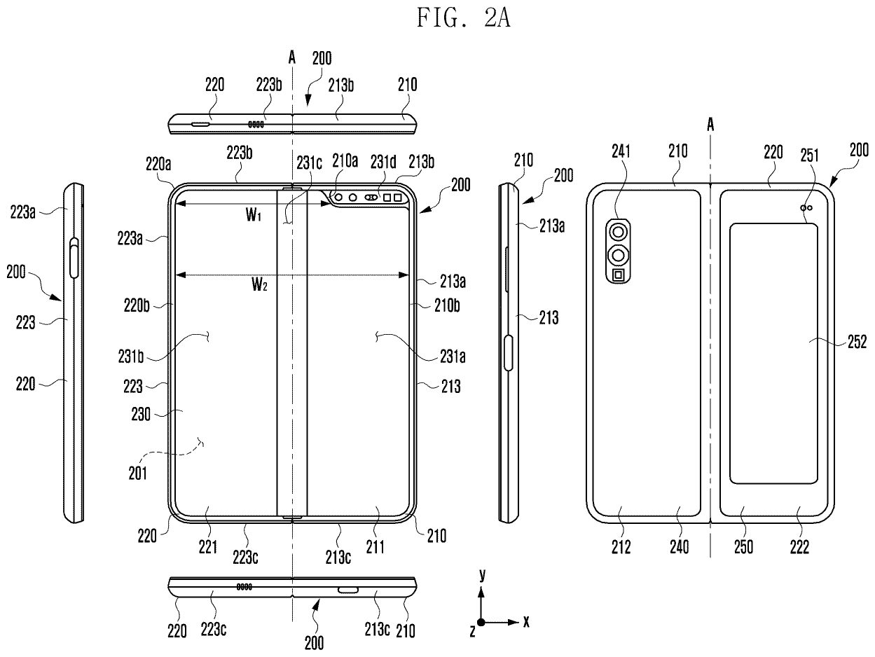

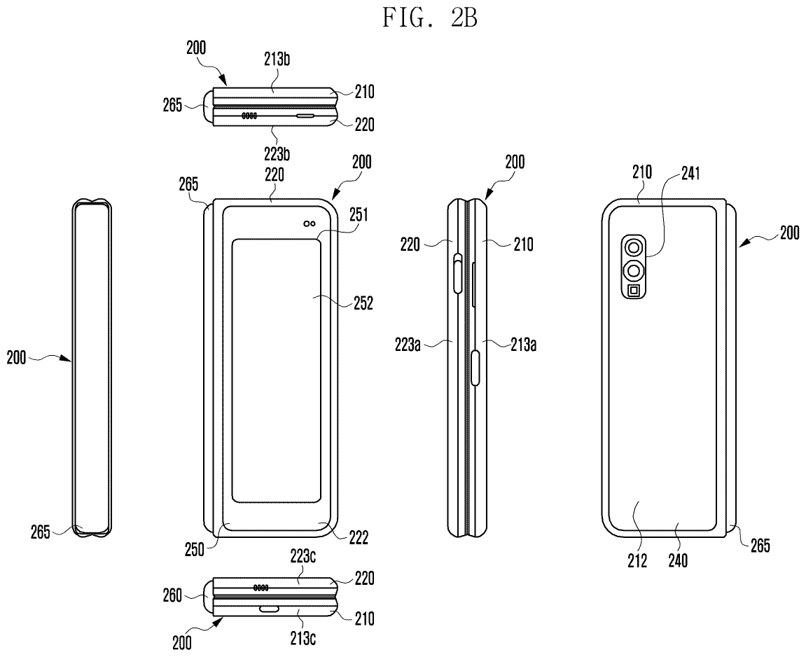

FIG. 2A is a diagram illustrating an unfolded state of an example electronic device 200 according to various embodiments. FIG. 2B is a diagram illustrating a folded state of the electronic device 200 of FIG. 2A according to various embodiments.

The electronic device 200 of FIGS. 2A and 2B may be at least partially similar to the electronic device 101 of FIG. 1 or may include various embodiments of the electronic device.

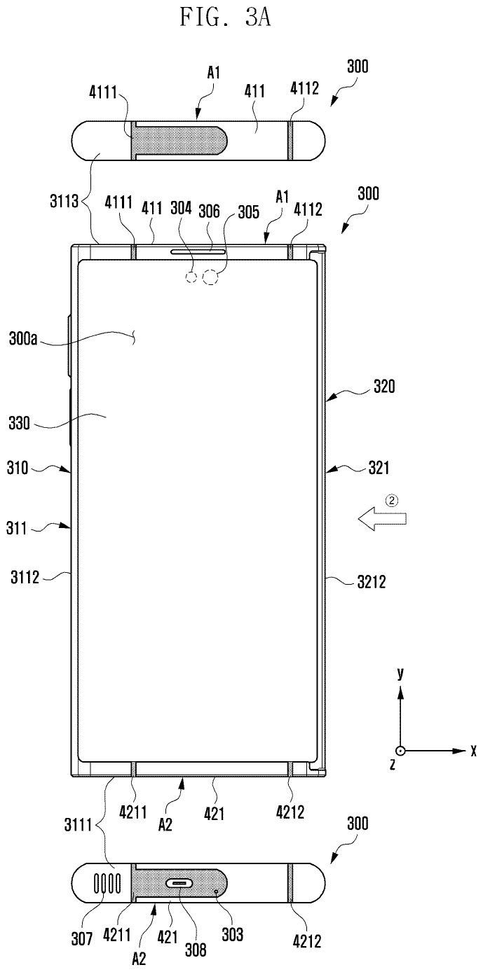

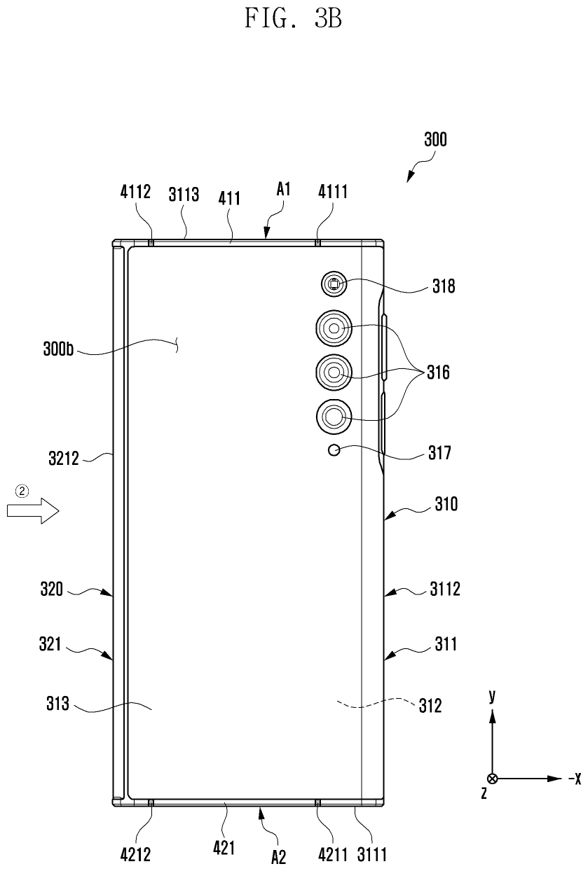

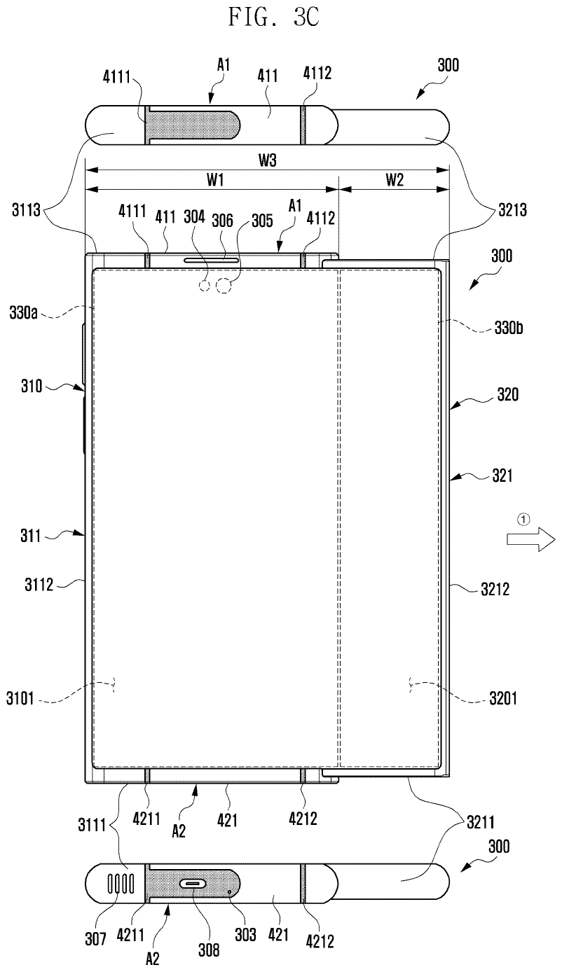

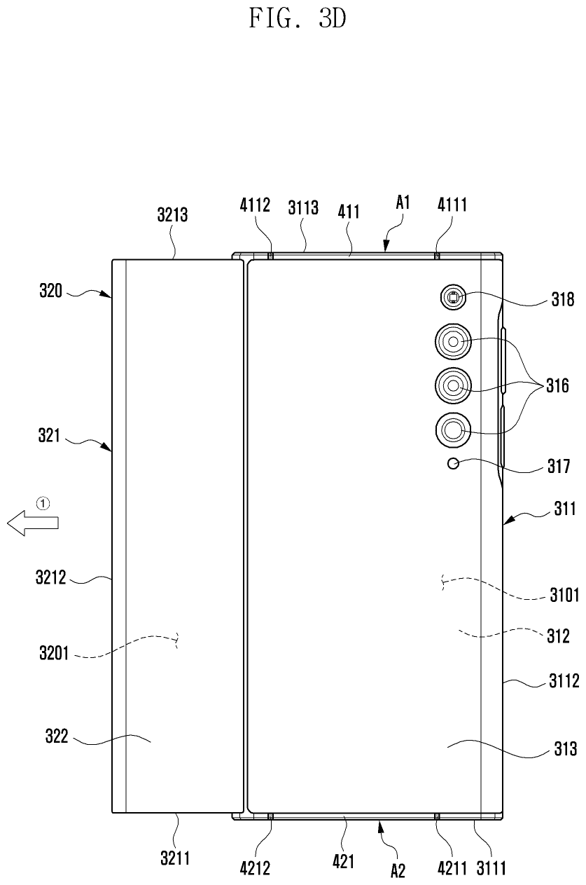

With reference to FIG. 2A, the electronic device 200 may include a pair of housing structures 210 and 220 that are rotatably coupled to each other through a hinge structure (e.g., the hinge structure 264 of FIG. 3) to be folded with respect to each other, a hinge cover 265 that covers a foldable portion of the pair of housing structures 210 and 220, and a display 230 (e.g., a flexible display or a foldable display) that is disposed in a space formed by the pair of housing structures 210 and 220. In this disclosure, the surface on which the display 230 is disposed may be defined as the front surface of the electronic device 200, and the surface opposite to the front surface may be defined as the rear surface of the electronic device 200. In addition, a surface surrounding the space between the front surface and the rear surface may be defined as a side surface of the electronic device 200.

In an embodiment, a pair of housing structures 210 and 220 may include a first housing structure 210 including a sensor area 231d, a second housing structure 220, a first rear cover 240, and a second rear cover 250. The pair of housing structures 210 and 220 of the electronic device 200 are not limited to the shapes and combinations illustrated in FIGS. 2A and 2B, and may be implemented by other shapes or combinations and/or combinations of parts. For example, in an embodiment, the first housing structure 210 and the first rear cover 240 may be formed integrally, and the second housing structure 220 and the second rear cover 250 may be formed integrally.

According to an embodiment, the first housing structure 210 and the second housing structure 220 may be disposed on both sides with respect to the folding axis (A axis) as the center, and may have an overall symmetrical shape with respect to the folding axis (A axis). According to an embodiment, the angle or distance between the first housing structure 210 and the second housing structure 220 may vary depending on whether the state of the electronic device 200 is an unfolded state (flat stage or closing state), a folded state (folding state), or an intermediate state. According to an embodiment, unlike the second housing structure 220, the first housing structure 210 may additionally include a sensor area 231d in which various sensors are disposed, but may have a mutually symmetrical shape in the other areas. In an embodiment, the sensor disposition area 231d may be additionally disposed in or replaced with at least a portion of the second housing structure 220.

In an embodiment, the first housing structure 210 may be connected to a hinge structure (not shown) in an unfolded state of the electronic device 200 and may include a first surface 211 that is disposed to face the front surface of the electronic device 200 and, a second surface 212 that faces in an opposite direction to the first surface 211, and a first lateral member 213 that surrounds at least a portion of the space between the first surface 211 and the second surface 212. In an embodiment, the first lateral member 213 may include a first side surface 213a that is disposed parallel to a folding axis (A axis), a second side surface 213b that extends from one end of the first side surface 213a in a direction perpendicular to the folding axis, and a third side surface 213c that extends from the other end of the first side surface 213a in a direction perpendicular to the folding axis (A axis).

In an embodiment, the second housing structure 220 may be connected to a hinge structure (e.g., the hinge structure 264 of FIG. 3) in an unfolded state of the electronic device 200 and may include a third surface 221 disposed to face the front surface of the electronic device 200, a fourth surface 222 that faces in an opposite direction to the third surface 221, and a second lateral member 321 that surrounds at least a portion of the space between the third surface 221 and the fourth surface 222. In an embodiment, the second lateral member 223 may include a fourth side surface 223a disposed parallel to the folding axis (A axis), a fifth side surface 223b that extends from one end of the fourth side surface 223a in a direction perpendicular to the folding axis (A axis), and a sixth side surface 223c that extends from the other end of the fourth side surface 223a in a direction perpendicular to the folding axis (A axis). In an embodiment, the third surface 221 may be disposed to face the first surface 211 in a folded state.

In an embodiment, the electronic device 200 may include a recess 201 formed to accommodate a display 230 through a structural shape combination of a first housing structure 210 and a second housing structure 220. The recess 201 may have substantially the same size as the display 230. In an embodiment, because of the sensor area 231d, the recess 201 may have two or more different widths in a direction perpendicular to the folding axis (A axis). For example, the recess 201 may have a first width W1 between a first portion 220a of the second housing structure 220 that is parallel to the folding axis (A axis) and a first portion 210a formed at the edge of the sensor area 231d of the first housing structure 210, and a second width W2 formed by a second portion 220b of the second housing structure 220 and a second portion 210b that is parallel to the folding axis (A axis) and does not correspond to the sensor area 213d of the first housing structure 210. In this case, the second width W2 may be formed longer than the first width W1. For example, the recess 201 may be formed to have a first width W1 formed from a first portion 210a of a first housing structure 210 having a mutually asymmetrical shape to a first portion 220a of a second housing structure 220, and a second width W2 formed from a second portion 210b of the first housing structure 210 having a mutually symmetrical shape to a second portion 220b of the second housing structure 220. In an embodiment, the first portion 210a and the second portion 210b of the first housing structure 210 may be formed to have different distances from the folding axis (A axis). The width of the recess 201 is not limited to the illustrated example. In various embodiments, the recess 201 may have two or more different widths because of the shape of the sensor area 213d or the asymmetrical shape of the first housing structure 210 and the second housing structure 220.

In an embodiment, at least a portion of the first housing structure 210 and the second housing structure 220 may be formed of a metallic or non-metallic material having a rigidity selected to support the display 230.

In an embodiment, the sensor area 231d may be formed to have a predetermined area adjacent to one corner of the first housing structure 210. However, the disposition, shape, or size of the sensor area 231d is not limited to the illustrated example. For example, in an embodiment, the sensor area 231d may be provided at another corner of the first housing structure 210 or any area between the upper corner and the lower corner. In an embodiment, the sensor area 231d may be disposed in at least a portion of the second housing structure. In an embodiment, the sensor area 231d may be disposed to extend to the first housing structure 210 and the second housing structure 220. In an embodiment, the electronic device 200 may be configured to have components for performing various functions that are disposed to be exposed on the front surface of the electronic device 200 through the sensor area 213d or through one or more openings provided in the sensor area 231d. In various embodiments, the components may include, for example, at least one of a front camera device, a receiver, a proximity sensor, an ambient light sensor, an iris recognition sensor, an ultrasonic sensor, or an indicator.

In an embodiment, the first rear cover 240 may be disposed on the second surface 212 of the first housing structure 210 and may have a substantially rectangular periphery. In an embodiment, at least a portion of the periphery may be wrapped by the first housing structure 210. Similarly, the second rear cover 250 may be disposed on the fourth surface 222 of the second housing structure 220 and may have at least a portion of its periphery wrapped by the second housing structure 220.

In an embodiment, the first rear cover 240 and the second rear cover 250 may have substantially symmetrical shapes with respect to the folding axis (A axis). In various embodiments, the first rear cover 240 and the second rear cover 250 may include various different shapes. In various embodiments, the first rear cover 240 may be formed integrally with the first housing structure 210, and the second rear cover 250 may be formed integrally with the second housing structure 220.

In an embodiment, the first rear cover 240, the second rear cover 250, the first housing structure 210, and the second housing structure 220 may be coupled to each other to provide a space in which various components of the electronic device 200 (e.g., a printed circuit board, an antenna module, a sensor module, or a battery) are disposed. In an embodiment, one or more components may be disposed or visually exposed on the rear surface of the electronic device 200. For example, one or more components or sensors may be visually exposed through the first rear area 241 of the first rear cover 240. In various embodiments, the sensor may include a proximity sensor, a rear camera device, and/or a flash. In an embodiment, at least a portion of the sub-display 252 may be visible through the second rear area 251 of the second rear cover 250.

The display 200 may be disposed on a space formed by the foldable housings 210 and 220. For example, the display 200 may be mounted in a recess (e.g., the recess 201 of FIG. 2A) formed by a pair of housing structures 210 and 220 and may be disposed to occupy substantially most of the front surface of the electronic device 200. Accordingly, the front surface of the electronic device 200 may include the display 230 and a portion (e.g., an edge portion) of the first housing structure 210 adjacent to the display 230 and a portion (e.g., an edge portion) of the second housing structure 220. In an embodiment, the rear surface of the electronic device 200 may include a first rear cover 240, a portion (e.g., an edge portion) of a first housing structure 210 adjacent to the first rear cover 240, a second rear cover 250, and a portion (e.g., an edge portion) of a second housing structure 220 adjacent to the second rear cover 250.

In an embodiment, the display 230 may refer to a display in which at least a portion of the display can be transformed into a flat or curved surface. In an embodiment, the display 230 may include a folding area 231c, a first area 231a disposed on one side (e.g., a right area of the folding area 231c) with respect to the folding area 231c, and a second area 231b disposed on the other side (e.g., a left area of the folding area 231c). For example, the first area 231a may be disposed on the first surface 211 of the first housing structure 210, and the second area 231b may be disposed on the third surface 221 of the second housing structure 220. In an embodiment, the division of areas of the display 230 is an example, and the display 230 may be divided into a plurality of areas (for example, four or more or two) depending on the structure or function. For example, in FIG. 2A, the areas of the display 230 may be divided by a folding area 231c that extends parallel to the y-axis or a folding axis (A-axis), but in various embodiments, the display 230 may be divided into areas based on another folding area (for example, a folding area parallel to the x-axis) or another folding axis (for example, a folding axis parallel to the x-axis). The above-described display area division is merely a physical division by a pair of housing structures 210 and 220 and a hinge structure (e.g., the hinge structure 264 of FIG. 3), and in reality, the display 230 may display one entire screen through a pair of housing structures 210 and 220 and a hinge structure (e.g., the hinge structure 264 of FIG. 3). In an embodiment, the first area 231a and the second area 231b may have an overall symmetrical shape centered on the folding area 231c. However, the first area 231a may include a cut notch area (e.g., the notch area 233 of FIG. 3) depending on the presence of the sensor area 231d, but may have a shape symmetrical with respect to the second area 231b in other areas. For example, the first area 231a and the second area 231b may include a portion having a symmetrical shape and a portion having an asymmetrical shape.

With reference to FIG. 2B, the hinge cover 265 may be configured to be disposed between the first housing structure 210 and the second housing structure 220 to cover internal components (e.g., the hinge structure 264 of FIG. 3). In an embodiment, the hinge cover 265 may be covered by a portion of the first housing structure 210 and the second housing structure 220 or exposed to the outside, depending on the operating state (flat state or folded state) of the electronic device 200.

For example, as illustrated in FIG. 2A, when the electronic device 200 is in an unfolded state, the hinge cover 265 may not be exposed because it is covered by the first housing structure 210 and the second housing structure 220. For example, as illustrated in FIG. 2B, when the electronic device 200 is in a folded state (e.g., a completely folded state), the hinge cover 265 may be exposed to the outside between the first housing structure 210 and the second housing structure 220. For example, when the first housing structure 210 and the second housing structure 220 are in an intermediate state where they are folded at a certain angle, the hinge cover 265 may be partially exposed to the outside of the electronic device 200 between the first housing structure 210 and the second housing structure 220. In this case, the exposed area may be less than that in the completely folded state. In an embodiment, the hinge cover 265 may include a curved surface.

Hereinafter, an operation of the first housing structure 210 and the second housing structure 220 and each area of the display 230 according to the operating state (e.g., flat state and folded state) of the electronic device 200 will be described.

In an embodiment, when the electronic device 200 is in a flat state (e.g., the state of FIG. 2A), the first housing structure 210 and the second housing structure 220 may form an angle of 180 degrees, and the first area 231a and the second area 231b of the display may be disposed to face the same direction. In addition, the folding area 231c may form the same plane as the first area 231a and the second area 231b.

In an embodiment, when the electronic device 200 is in a folded state (e.g., the state of FIG. 2B), the first housing structure 210 and the second housing structure 220 may be disposed to face each other. The first area 231a and the second area 231b of the display 230 may form a narrow angle (e.g., between 0 and 10 degrees) with each other and may face each other. The folding area 231c may be formed as a curved surface having at least a portion of a predetermined curvature.

In an embodiment, when the electronic device 200 is in an intermediate state, the first housing structure 210 and the second housing structure 220 may be disposed at a certain angle with respect to each other. The first area 231a and the second area 231b of the display 230 may form an angle that is greater than the angle in the folded state and less than the angle in the unfolded state. The folding area 231c may be formed as a curved surface having at least a portion of a certain curvature, and the curvature at this time may be less than that in the folded state.

The example embodiment relates to an infolding method in which the first surface 211 of the first housing structure 210 and the third surface 221 of the second housing structure 220 are disposed to face each other when the electronic device 200 is in a folded state. However, various embodiments described below may also be applied to an outfolding method in which the second surface 212 of the first housing structure 210 and the fourth surface 222 of the second housing structure 220 are disposed to face each other when the electronic device 310 is in a folded state.

FIGS. 3A and 3B are diagrams illustrating the front surface and rear surface of an example electronic device in a slide-in state according to various embodiments. FIGS. 3C and 3D are diagrams illustrating the front surface and rear surface of an example electronic device in a slide-out state according to various embodiments.

The electronic device 300 of FIGS. 3A to 3D may be at least partially similar to the electronic device 101 of FIG. 1 or may further include various embodiments of the electronic device.

With reference to FIGS. 3A to 3D, an electronic device 300 may include a first housing 310 (e.g., a first housing structure or a base housing), a second housing 320 (e.g., a second housing structure or a slide housing) movably coupled to the first housing 310 in a designated direction (e.g., x-axis direction) and within a designated distance, and a flexible display 330 (e.g., an expandable display or a stretchable display) disposed to be supported by at least a portion of the first housing 210 and the second housing 320. According to an embodiment, at least a portion of the second housing 320 may be accommodated in a first space 310 of the first housing 310, thereby transitioning to a slide-in state. According to an embodiment, the electronic device 300 may include a bendable member (e.g., a multi-joint hinge module or a multi-bar assembly) that forms at least partially the same plane as at least a portion of the first housing 310 in a slide-out state and is at least partially accommodated into a second space 3201 of the second housing 320 in a slide-in state. According to an embodiment, at least a portion of the flexible display 330 may be accommodated into the internal space 3201 of the second housing 320 while being supported by the bendable member in the slide-in state, thereby being disposed not to be visible from the outside. According to an embodiment, at least a portion of the flexible display 330 may be disposed to be visible from the outside while being supported by a bendable member that forms at least partially the same plane as the first housing 310 in the slide-out state.

According to various embodiments, the electronic device 300 may include a front surface 300a (e.g., a first surface), a rear surface 300b (e.g., a second surface) that faces opposite to the front surface 300a, and a side surface (not shown) that surrounds a space between the front surface 300a and the rear surface 300b. According to an embodiment, the electronic device 300 may include a first housing 310 including a first lateral member 311 and a second housing 320 including a second lateral member 321. In an embodiment, the first lateral member 311 may include a first side surface 3111 having a first length along a first direction (e.g., x-axis direction), a second side surface 3112 that extends from the first side surface 3111 to have a second length longer than the first length along a direction substantially perpendicular to the first side surface 3111 (e.g., y-axis direction), and a third side surface 3113 that extends from the second side surface 3112 substantially parallel to the first side surface 3111 and having the first length. In an embodiment, the first lateral member 311 may be formed at least partially of a conductive material (e.g., metal). According to an embodiment, at least a portion of the first lateral member 311 may include a first support member 312 that extends to at least a portion of the first space 3101 of the first housing 310.

According to various embodiments, the second lateral member 321 may include a fourth side surface 3211 that corresponds at least partially to the first side surface 3111 and has a third length, a fifth side surface 3212 that extends from the fourth side surface 3211 in a direction substantially parallel to the second side surface 3112 and has a fourth length that is longer than the third length, and a sixth side surface 3213 that extends from the fifth side surface 3212 to correspond to the third side surface 3113 and has a third length. According to an embodiment, the second lateral member 321 may be formed at least partially of a conductive material (e.g., metal). According to an embodiment, at least a portion of the second lateral member 321 may include a second support member 322 that extends to at least a portion of the second space 3201 of the second housing 320. According to an embodiment, the first side surface 3111 and the fourth side surface 3211 and the third side surface 3113 and the sixth side surface 3213 may be slidably coupled to one another. According to an embodiment, in the slide-in state, the fourth side surface 3211 may be disposed to overlap the first side surface 3111 to be substantially invisible from the outside. According to an embodiment, in the slide-in state, the sixth side surface 3213 may be disposed to overlap the third side surface 3113 to be substantially invisible from the outside. In an embodiment, at least a portion of the fourth side surface 3211 and the sixth side surface 3213 may be disposed to be at least partially visible from the outside in the slide-in state. According to an embodiment, in the slide-in state, the second support member 322 may be disposed to overlap the first support member 312 to be substantially invisible from the outside. In an embodiment, a portion of the second support member 322 may be disposed to overlap the first support member 312 to be invisible from the outside in the slide-in state, and the remaining portion of the second support member 322 may be disposed to be visible from the outside. According to an embodiment, the electronic device may include a rear cover 313 disposed on at least a portion of the first housing 310 at the rear surface 300b. According to an embodiment, the rear cover 313 may be disposed through at least a portion of the first support member 312. In an embodiment, the rear cover 313 may be formed integrally with the first lateral member 311. According to an embodiment, the rear cover 313 may be formed of a polymer, a coated or colored glass, a ceramic, a metal (e.g., aluminum, stainless steel (STS), or magnesium), or a combination of at least two of the foregoing materials. In an embodiment, the rear cover 313 may extend to at least a portion of the first lateral member 311. In an embodiment, at least a portion of the first support member 312 may be replaced by the rear cover 313. In an embodiment, the electronic device 300 may include another rear cover (e.g., a second rear cover) in the second housing 320 that is disposed on at least a portion of the second support member 322, or that replaces at least a portion of the second support member 322.

According to various embodiments, the electronic device 300 may include a flexible display 330 disposed to be supported by at least a portion of the first housing 310 and the second housing 320. According to an embodiment, the flexible display 330 may include a first portion 330a (e.g., a flat portion) that is always visible from the outside and a second portion 330b (e.g., a bendable portion) that extends from the first portion 330a and is at least partially accommodated into a second space 3201 of the second housing 320 not to be visible from the outside in a slide-in state. According to an embodiment, the first portion 330a may be disposed to be supported by the first housing 310, and the second portion 330b may be disposed to be at least partially supported by the bendable member. According to an embodiment, the flexible display 330 may be disposed to extend from the first portion 330a while being supported by the bendable member, form substantially the same plane as the first portion 330a, and be visible from the outside, while the second housing 320 is slid out along a designated direction (direction \textcircled{1}). According to an embodiment, the second portion 330b of the flexible display 330 may be accommodated in the second space 3201 of the second housing 320 in a state where the second housing 320 is slid in along a designated direction (\textcircled{2} direction) and may be disposed not to be visible from the outside. Accordingly, the electronic device 300 may induce the display area of the flexible display 230 to vary as the second housing 320 is moved in a sliding manner along a designated direction (e.g., x-axis direction) from the first housing 310.

According to various embodiments, the first housing 310 and the second housing 320 may be operated in a sliding manner so that the overall width thereof is variable with respect to each other. According to an embodiment, the electronic device 300 may be configured to have a first width W1 from the second side surface 3112 to the fifth side surface 3212 in the slide-in state. According to an embodiment, the electronic device 300 may be configured to have a third width W3 greater than the first width W1 by moving at least a portion of the bendable member accommodated in the second space 3201 of the second housing 310 to have an additional second width W2 in the slide-in state. For example, the flexible display 330 may have a display area substantially corresponding to the first width W1 in the slide-in state, and may have an extended display area substantially corresponding to the third width W3 in the slide-out state.

According to various embodiments, the slide-in/slide-out operation of the electronic device 300 may be performed automatically. For example, when the electronic device 300 detects a triggering operation for transitioning from the slide-in state to the slide-out state or from the slide-out state to the slide-in state while the drive

module is not in operation, the electronic device 300 may operate the drive module disposed inside the electronic device 300. According to an embodiment, the triggering operation may include an operation for detecting a movement distance by which the second housing is moved by a push-pull section in the direction (e.g., direction \textcircled{2}) in which the second housing is to be slid in. For example, the electronic device 300 may be operatively connected to a processor (e.g., the processor 120 of FIG. 1) and may operate or stop the drive module through a drive motor control module for controlling (e.g., servo control) the drive motor of the drive module.

According to various embodiments, the electronic device 300 may be equipped with a sensor (e.g., the sensor module 192 of FIG. 1) that senses a slide-in/slide-out motion. The sensor 192 may detect a slide-in/slide-out motion of the electronic device 300 and may detect a length between the first housing 310 and the second housing 320. The length between the first housing 310 and/or the second housing 320 may refer to the degree of slide-in (or slide-out) of the second housing structure 220 (or the first housing 310). According to an embodiment, the sensor 192

may include at least one of a magnetic detection sensor (e.g., Hall IC) for measuring the length between the first housing 310 and/or the second housing 320, and a capacitor

sensor for measuring a change in the capacitor value of a touch screen panel included in the flexible display 330. In addition, the sensor 192 may include operation information (e.g., torque) of a motor that performs slide-in and/or slide-out between the first housing 310 and/or the second housing 320, an optical sensor, and/or a strain gauge sensor for measuring a resistance value that changes according to the slide-in and/or slide-out of the first housing 310 and/or the second housing 320.

According to various embodiments, the electronic device 300 may include at least one of an input device (e.g., a microphone 303), an audio output device (e.g., a call receiver 306 or a speaker 307), a sensor module 304 and 317, a camera module (a first camera module 305 or a second camera module 316), a connector port 308, a key input device (not shown), or an indicator (not shown) disposed in a first space 3101 of a first housing 310. In an embodiment, the electronic device 300 may be configured such that at least one of the above-described components is omitted, or other components are additionally included. In an embodiment, at least one of the above-described components may be disposed in a second space 3201 of a second housing 320.

According to various embodiments, the input device may include a microphone 303. In various embodiments, the input device (e.g., microphone 303) may include a plurality of microphones disposed to detect the direction of sound. The audio output device may include, for example, a call receiver 306 and a speaker 307. According to an embodiment, the speaker 307 may be exposed to the outside through at least one speaker hole formed in the first housing 310 in a slide-out state. According to an embodiment, the connector port 308 may be exposed to the outside through a connector port hole formed in the first housing 310 in a slide-out state. In various embodiments, the call receiver 306 may include a speaker (e.g., a piezo speaker) that operates without a separate speaker hole.

According to various embodiments, the sensor module 304 and 317 may generate an electrical signal or data value corresponding to an internal operating state of the electronic device 300 or an external environmental state. The sensor module 304 and 317 may include, for example, a first sensor module 304 (e.g., a proximity sensor or an ambient light sensor) disposed on the front surface 300a of the electronic device 300 and/or a second sensor module 317 (e.g., a heart rate monitoring (HRM) sensor) disposed on the rear surface 300b. According to an embodiment, the first sensor module 304 may be disposed on the front surface 300a of the electronic device 300 under the flexible display 330. According to an embodiment, the first sensor module 304 and/or the second sensor module 317 may include at least one of a proximity sensor, an ambient light sensor, a time of flight (TOF) sensor, an ultrasonic sensor, a fingerprint recognition sensor, a gesture sensor, a gyro sensor, a barometric pressure sensor, a magnetic sensor, an acceleration sensor, a grip sensor, a color sensor, an infrared (IR) sensor, a biometric sensor, a temperature sensor, or a humidity sensor.

According to various embodiments, the camera module may include a first camera module 305 disposed on the front surface 300a of the electronic device 300 and a second camera module 316 disposed on the rear surface 300b. According to an embodiment, the electronic device 300 may include a flash 318 disposed near the second camera module 316. According to an embodiment, the camera modules 305 and 316 may include one or more lenses, an image sensor, and/or an image signal processor. According to an embodiment, the first camera module 305 may be disposed under the flexible display 330 and configured to capture an object through a portion of an active area of the flexible display 330. According to an embodiment, the flash 318 may include, for example, a light emitting diode or a xenon lamp.

According to various embodiments, among the camera modules, the first camera module 305 and among the sensor modules 304 and 317, some of the sensor modules 304 may be disposed to detect an external environment through the flexible display 330. For example, the first camera module 305 or some of the sensor modules 304 may be disposed to be in contact with the external environment through a transparent area or a perforated opening formed in the flexible display 330 in the first space 3201 of the first housing 310. According to an embodiment, an area of the flexible display 330 that faces the first camera module 305 may be formed as a transparent area having a designated transmittance as part of an area for displaying content. According to an embodiment, the transparent area may be formed to have a transmittance in a range of about 5% to about 20%. Such a transparent area may include an area overlapping with an effective area (e.g., a field of view area) of the first camera module 305 through which light passes to be imaged by the image sensor to create an image. For example, the transparent area of the flexible display 330 may include an area having a lower pixel density and/or wiring density than the surrounding area. For example, the transparent area may replace the opening described above. For example, some camera modules 305 may include an under-display camera (UDC). In various embodiments, some sensor modules 304 may be disposed to perform their functions without being visually exposed through the flexible display 330 in the interior space of the electronic device 300.

According to various embodiments, the electronic device 300 may include at least one antenna A1 and A2 electrically connected to a wireless communication circuit (e.g., the wireless communication module 192 of FIG. 1) disposed in a first space 3101 of the first housing 310. According to an embodiment, the at least one antenna A1 and A2 may include a first antenna A1 disposed in an upper area of the electronic device 300 and a second antenna A2 disposed in a lower area. In an embodiment, the electronic device 300 may further include at least one additional antenna disposed on a second side surface 3112 of the first housing 310 and/or a fifth side surface 3212 of the second housing 320. According to an embodiment, the first antenna A1 may include a first conductive portion 411 segmented through at least one non-conductive portion 4111 and 4112 at a third side surface 3113 of the first lateral member 311. According to an embodiment, the first conductive portion 411 may be disposed to be segmented through a first non-conductive portion 4111 and a second non-conductive portion 4112 spaced apart at a designated interval, and may be electrically connected to a wireless communication circuit (e.g., the wireless communication module 192 of FIG. 1). According to an embodiment, the second antenna A2 may include a second conductive portion 421 segmented through at least one non-conductive portion 4211 and 4212 on the first side surface 3111 of the first lateral member 311. According to an embodiment, the second conductive portion 421 may be disposed to be segmented through a third non-conductive portion 4211 and a fourth non-conductive portion 4212 spaced apart at a designated interval, and may be electrically connected to a wireless communication circuit (e.g., the wireless communication module 192 of FIG. 1). According to an embodiment, a wireless communication circuit (e.g., the wireless communication module 192 of FIG. 1) may be configured to transmit and/or receive a wireless signal in a designated frequency band (e.g., about 800 MHz to 6000 MHz) (e.g., a legacy band) through the first conductive portion 411 and/or the second conductive portion 412. In various embodiments, the electronic device 200 may further include at least one antenna module (e.g., an antenna module for short-range wireless communication, a 5G antenna module, or an antenna structure) disposed in an internal space (e.g., the first space 2101 or the second space 2201) and disposed to transmit and receive a wireless signal in a frequency band ranging from about 3 GHz to 100 GHz through another wireless communication circuit (e.g., the wireless communication module 192 of FIG. 1).

An electronic device 300 according to various example embodiments of the present disclosure may include a drive module disposed in an internal space (e.g., a second space 3201) for a slide-in/slide-out operation. According to an embodiment, the electronic device 300 may use a push-pull operation as a triggering operation for driving the drive module. For example, when the electronic device 300 detects a triggering operation in which the second housing 320 is pressed in a direction (e.g., direction \textcircled{2}) in which the second housing 320 is to be slid in by a push-pull section while the drive module is not driven and in a slide-in state, the electronic device 300 may automatically slide the second housing 320 out through the drive module (push and pull-out operation) (e.g., slide-out operation). According to an embodiment, when the electronic device 300 detects a triggering operation in which the second housing 320 is pressed by a push-pull section in the direction (e.g., direction \textcircled{2}) in which the second housing 320 is to be slid in when the drive module is not driven and in a slide-out state, the electronic device 300 may automatically slide the second housing 300 in through the drive module (push and pull-in operation) (e.g., slide-in operation). Accordingly, the electronic device 300 may provide an intuitive and novel experience and help improve usability by providing the user with an intuitive triggering means (switching means) for the slide-in/slide-out operation.

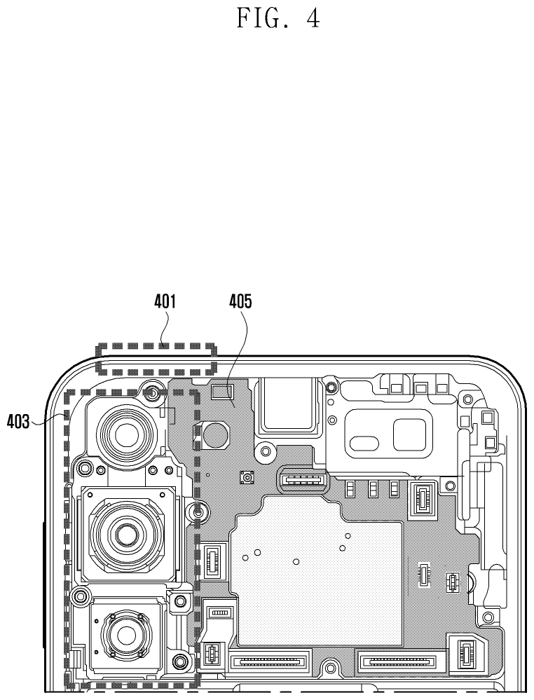

FIG. 4 is a diagram illustrating an antenna and at least one component in an electronic device according to one embodiment.

With reference to FIG. 4, an electronic device (e.g., the electronic device 100 of FIG. 1) may include an antenna 401, a camera 403 and a printed circuit board 405.

The antenna 401 may be electrically connected to a wireless communication module (e.g., the communication circuitry 160 of FIG. 1) disposed on a portion of a printed circuit board 405. The antenna 401 may be electrically connected to a ground implemented on the printed circuit board 405.

The antenna 401 may radiate a signal of a specific frequency band transmitted by the communication circuitry 160. When the antenna 401 radiates a signal, a portion of the signal may be radiated into the interior of the electronic device 101. When a portion of the signal is radiated into the interior of the electronic device 101, a portion of the signal may affect the operation of at least one component (e.g., a camera 403) adjacent to the antenna 401.

According to an example, when the antenna 401 radiates a signal, the camera 403 may malfunction (e.g., the camera 403 unintentionally reboots, or the camera 403 fails to capture some frames).

In order to reduce (or prevent) malfunction of the camera 403, the electronic device 101 may reduce the intensity of the signal radiated by the antenna 401 (e.g., Tx power backoff). However, a reduction in the intensity of the signal radiated by the antenna 401 may reduce the performance of wireless communication.

Furthermore, when the electronic device 100 is implemented to include a foldable housing, the distance between antennas that output signals may change depending on the angular change between the first housing structure (e.g., the first housing structure 210 of FIG. 2A) and the second housing structure (e.g., the second housing structure 220 of FIG. 2A). Changes in the distance between the antennas may cause a degradation in the performance of wireless communication.

Furthermore, when the electronic device 100 is implemented to include a rollable housing, the distance between antennas that output signals may change depending on the change in distance between the first housing structure (e.g., the first housing structure 310 of FIG. 3A) and the second housing structure (e.g., the second housing structure 320 of FIG. 3A). Changes in the distance between the antennas may cause a degradation in the performance of wireless communication.

When the electronic device 100 detects a degradation in wireless communication performance while performing short-range wireless communication, the communication circuitry (e.g., the communication circuitry 160 of FIG. 1) of the electronic device 100 may attempt to improve the signal transmission success rate through short-range wireless communication by adjusting the modulation and coding scheme (MCS) level and/or changing the signal transmission method. The signal transmission method may include a diversity transmission mode, where signals containing the same data are transmitted through each of the plurality of antennas of the electronic device 100, and a spatial multiplexing mode, where signals containing different data are transmitted through each of the plurality of antennas. The spatial multiplexing mode may achieve high transmission rates by transmitting signals each containing portions of the data, while the diversity transmission mode may improve transmission success rates by transmitting signals containing the same data.

The communication circuitry 160 according to the comparative example may improve the transmission success rate of the signal by decreasing the MCS level when the quality of a short-range wireless communication signal is degraded. However, adjusting the MCS level may not significantly contribute to improving the transmission success rate of the signal. Therefore, the communication circuitry 160 may attempt to improve the signal transmission success rate by changing the signal transmission method. According to one example, the communication circuitry 160 may switch from the spatial multiplexing mode to the diversity transmission mode upon detecting that the quality of a signal received from an external electronic device (not shown) connected through short-range wireless communication is less than (or less than or equal to) a designated level. However, the designated level may be a predetermined value regardless of the state of the electronic device 100. Therefore, the communication circuitry 160 may not switch to a diversity transmission mode, in the case that the strength of the signal received from the external electronic device is greater than the designated size, in a state (e.g., when the angle between the first housing structure 210 and the second housing structure 220 of the electronic device 100 is less than or equal to the designated level, or when the electronic device 100 is performing Tx backoff) where a transition to a diversity transmission mode should be performed rapidly, and delaying the switch to diversity transmission mode may cause a degradation in the performance of short-range wireless communication.

Hereinafter, examples are described for preventing (or reducing) the aforementioned phenomenon by comparing different values and quality of the signal based on whether an electronic device 100 satisfies designated conditions and switching to a diversity transmission mode based on the comparison results.

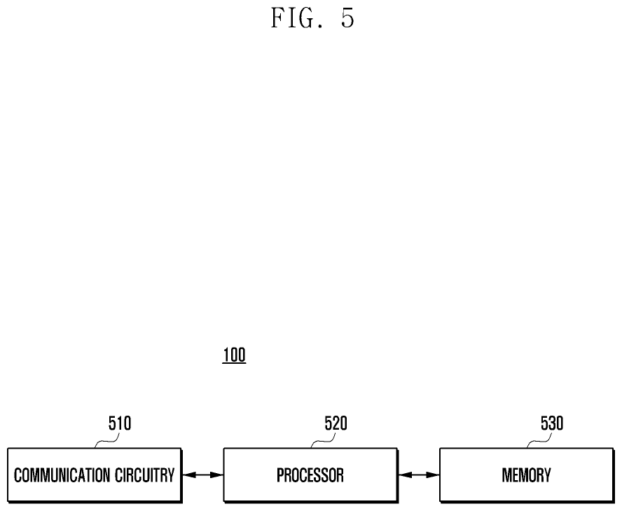

FIG. 5 is a block diagram illustrating an example configuration of an electronic device according to various embodiments.

With reference to FIG. 5, an electronic device (e.g., the electronic device 100 of FIG. 1) may include communication circuitry 510 (e.g., the communication circuitry 160 of FIG. 1), a processor (e.g., including processing circuitry) 520 (e.g., the processor 110 of FIG. 1), and/or a memory 530 (e.g., the memory 120 of FIG. 1).

The communication circuitry 510 may include communication circuitry supporting short-range wireless communication. Near-field wireless communication may include various types of near-field wireless communication supported by the electronic device 100. For example, the near-field wireless communication may be Wi-Fi.

The communication circuitry 510 may include various circuitry structures used for modulating and/or demodulating signals within the electronic device 100. For example, the communication circuitry 510 may modulate a baseband signal into a radio frequency (RF) band signal for output through at least one of a plurality of antennas (not shown), or demodulate an RF band signal received through at least one antenna into a baseband signal for transmission to the processor 520.

The communication circuitry 510 may be electrically (or operationally) connected to a plurality of antennas, and the communication circuitry 510 may support a transmission mode of signals related to the transmission of signals using the plurality of antennas. According to an example, the communication circuitry 510 may support a diversity transmission mode, which transmits signals containing the same data through each of the plurality of antennas of the electronic device 100, and a spatial multiplexing mode, which transmits signals containing different data through each of the plurality of antennas. The spatial multiplexing mode may achieve high transmission rates by transmitting signals each containing portions of the data, while the diversity transmission mode may improve transmission success rates by transmitting signals containing the same data.

The communication circuitry 510 may include a separate processor (or core) that performs encoding of data to be transmitted through short-range wireless communication or decoding of data received through short-range wireless communication. The communication circuitry 510 may achieve high data transmission speed and/or reception speed when transmitting data with a high MCS level, and may achieve high transmission and/or reception success rates when transmitting or receiving data with a relatively low MCS level.

The communication circuitry 510 may configure (or change, determine) the MCS level and/or configure (or change, determine) the transmission mode of the signal based on the quality of the signal received through short-range wireless communication. For example, the communication circuitry 510 may decrease the MCS level and/or configure the transmission mode of the signal to a diversity transmission mode based on the quality of the signal received through short-range wireless communication being less than a designated level. In another example, the communication circuitry 510 may also increase the MCS level and/or configure the transmission mode of the signal to a spatial multiplexing mode based on the quality of the signal received through short-range wireless communication being greater than or equal to a designated level.

The processor 520 may include various processing circuitry and may be electrically or operatively connected to the communication circuitry 510 and control the communication circuitry 510. The processor 520 may include at least one processor, and at least one processor may perform the following operations individually or collectively. The processor 520 may be the processor 110 shown in FIG. 1. Thus, the processor 520 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 530 may store instructions executable by the processor 520. The operations of the processor 520 described below may be performed based on the execution of instructions stored in the memory 530.

The processor 520 may control the communication circuitry 510 to search for external electronic devices connected through short-range wireless communication.

The processor 520 may control the communication circuitry 510 to broadcast a probe request message to search for external electronic devices. The probe request message may include information about the electronic device 100. For example, the probe request message may include various identification information (e.g., MAC address) that distinguishes the electronic device 100 from other electronic devices and performance information related to short-range wireless communication of the electronic device 100. Upon receiving the probe request message, the external electronic device may transmit a probe response message corresponding to the probe request message to the electronic device 100. Upon receiving the probe response message, the processor 520 may successfully complete the searching of the external electronic device.

Upon discovering the external electronic device, the processor 520 may perform an authentication procedure, an association procedure, and/or a security setup procedure with the external electronic device, and, upon completion of the aforementioned procedures, the processor 520 may complete a connection with the external electronic device through short-range wireless communication.

The processor 520 may complete the connection with the external electronic device through short-range wireless communication and perform short-range wireless communication with the external electronic device. As the processor 520 performs short-range wireless communication with the external electronic device, it may receive signals from the external electronic device. According to an example, the signal received from the external electronic device may be a signal containing at least a portion of user data related to performing a service using the short-range wireless communication, or it may be a signal related to configuring the short-range wireless communication (e.g., a beacon signal).

The processor 520 may control the communication circuitry 510 to identify the quality of the signal received from the external electronic device at a designated interval. The processor 520 may perform at least one operation to control the communication circuitry 510 based on the quality of the signal received from the external electronic device.

According to an example, the processor 520 may determine whether to switch the signal transmission mode of the communication circuitry 510 based on the quality of a signal received from an external electronic device. For example, the processor 520 may determine whether the communication circuitry 510 activates a diversity transmission mode based on whether the quality of the signal received from the external electronic device is less than a designated level.

According to an example, the processor 520 may configure a value for comparison with the quality of the signal received from the external electronic device differently depending on whether the electronic device 100 satisfies designated conditions. The designated condition may include a condition indicating a state where the electronic device 100 must quickly perform a transition to the diversity transmission mode.

According to an example, the designated condition may include a condition where, in the case that the electronic device 100 is implemented as a foldable housing, the angle between the first housing structure (e.g., the first housing structure 210 of FIG. 2A) and the second housing structure (e.g., the second housing structure 220 of FIG. 2A) is less than (or less than or equal to) a designated size. When the angle between the first housing structure 210 and the second housing structure 220 is less than or equal to a designated size, the distance between antennas performing signal output through short-range wireless communication may decrease and the decrease in distance between antennas may cause a degradation in the performance of short-range wireless communication.

The processor 520 may determine whether to activate the diversity transmission mode based at least in part on the quality of the signal received from the external electronic device being less than (less than or equal to) a first value when the angle between the first housing structure 210 and the second housing structure 220 is less than (less than or equal to) a designated size.

The processor 520 may determine not to activate the diversity transmission mode in the case that the quality of the signal received from the external electronic device is greater than or equal to (or greater than) a first value.

The processor 520 may identify whether the number of packets that failed to be transmitted to an external electronic device out of the packets it attempted to send is greater than or equal to (or greater than) a third value when the quality of the signal received from the external electronic device is less than (or less than or equal) to a first value.

The processor 520 may determine to activate the diversity transmission mode in the case that the number of packets that failed to be transmitted to an external electronic device out of the packets it attempted to send is greater than or equal to (or greater than) a third value. In addition, the processor 520 may determine not to activate the diversity transmission mode in the case that the number of packets that failed to be transmitted to an external device out of the packets it attempted to send is less than (or less than or equal to) the third value.

The processor 520 may determine whether to activate the diversity transmission mode based at least in part on the quality of the signal received from the external electronic device being less than (or less than or equal to) a second value when the angle between the first housing structure 210 and the second housing structure 220 is greater than or equal to (or greater than) a designated size.

The processor 520 may determine to not activate the diversity transmission mode in the case that the quality of the signal received from the external electronic device is greater than or equal to (or greater than) a second value.

The processor 520 may identify whether the number of packets that failed to be transmitted to an external electronic device out of the packets it attempted to send is equal to or greater than (or greater than) a fourth value when the quality of the signal received from the external electronic device is less than (or less than or equal to) a second value.

The processor 520 may determine to activate the diversity transmission mode in the case that the number of packets that failed to be transmitted to an external electronic device out of the packets it attempted to send is greater than or equal to (or greater than) the fourth value. In addition, the processor 520 may determine to not activate the diversity transmission mode in the case that the number of packets that failed to be transmitted to an external electronic device out of the packets it attempted to send is less than (or less than or equal to) the fourth value.

In the case that the processor 520 determines to activate the diversity transmission mode, the processor 520 may transmit a signal requesting activation of the diversity transmission mode to the communication circuitry 510. Upon receiving the signal requesting activation of the diversity transmission mode from the processor 520, the communication circuitry 510 may activate the diversity transmission mode. In the case that the processor 520 determines to activate the diversity transmission mode, the communication circuitry 510 may maintain the activation of the diversity transmission mode regardless of the quality of the signal received from the external electronic device. For example, the communication circuitry 510 may perform MCS level adjustment based on quality of the signal, but may be prohibited from performing the operation of switching from diversity transmission mode to spatial multiplexing mode.

In the case that the processor 520 determines to not activate the diversity transmission mode, the communication circuitry 510 may perform MCS level adjustment and/or switching of the signal transmission method based on the quality of the signal received from the external electronic device.

According to an example, the first value and the second value may be configured differently from each other. For example, the first value may be configured to be larger than the second value. In addition, the third value and the fourth value may be configured differently from each other. The third value may be configured to be smaller than the fourth value. The configurations may be to activate (or switch to) the diversity transmission mode more quickly when the electronic device 100 satisfies designated conditions.

In the case that the first value is configured to be larger than the second value, and a signal with a quality smaller than the first value but larger than the second value is received from an external electronic device, the processor 520 may control the communication circuitry 510 to activate the diversity transmission mode when the angle between the first housing structure 210 and the second housing structure 220 is less than (or less than or equal to) a designated size. The processor 520 may not switch the communication circuitry 510 to the diversity transmission mode when the angle between the first housing structure 210 and the second housing structure 220 is greater than or equal to (or greater than) a designated size, as it receives a signal from the external electronic device having a quality less than the first value but greater than the second value. For example, by configuring the value for comparison with the quality of the signal received from the external electronic device differently depending on whether the angle between the first housing structure 210 and the second housing structure 220 is less than (or less than or equal to) a designated size, the processor 520 may perform the switch to the diversity transmission mode more quickly as the quality of the signal received from the external electronic device degrades, thereby improving the transmission performance of short-range wireless communication.

In the case that the third value is configured to be smaller than the fourth value, the processor 520 may control the communication circuitry 510 to activate the diversity transmission mode when the angle between the first housing structure 210 and the second housing structure 220 is less than (or less than or equal to) a designated size, and the number of packets that failed to be transmitted to the external electronic device is greater than the third value and less than the fourth value. The processor 520 may not perform the operation of the communication circuitry 510 activating the diversity transmission mode when the angle between the first housing structure 210 and the second housing structure 220 is greater than or equal to a designated size, and the number of packets that failed to be transmitted to an external electronic device is greater than a third value and less than a fourth value. For example, by configuring the value for comparison with the number of packets that failed to be transmitted to an external electronic device differently depending on whether the angle between the first housing structure 210 and the second housing structure 220 is less than (or less than or equal to) a designated size, the processor 520 may perform the switch to the diversity transmission mode more quickly as the quality of the signal received from the external electronic device degrades, thereby improving the transmission performance of short-range wireless communication.

The processor 520 may identify the quality of the signal received from the external electronic device when the angle between the first housing structure 210 and the second housing structure 220 is greater than or equal to a designated size. The processor 520 may not perform an operation to activate the diversity transmission mode in the case that the quality of the signal received from the external electronic device is less than a first value and greater than a second value. The processor 520 may not transmit a signal requesting activation of the diversity transmission mode to the communication circuitry 510. The processor 520 may transmit a signal requesting activation of the diversity transmission mode to the communication circuitry 510, considering that the quality of the signal is less than the first value, upon detecting that the angle between the first housing structure 210 and the second housing structure 220 has changed to less than (or less than or equal to) a designated size. The communication circuitry 510, upon receiving the signal requesting activation of the diversity transmission mode from the processor 520, may activate the diversity transmission mode.

The processor 520 may identify the quality of the signal received from the external electronic device when the angle between the first housing structure 210 and the second housing structure 220 is less than (or less than or equal to) a designated size. The processor 520 may activate the diversity transmission mode when the quality of the signal received from the external electronic device is less than a first value and greater than a second value. After activating the diversity transmission mode, the processor 520 may control the communication circuitry 510 to terminate maintaining the diversity transmission mode, considering that the quality of the signal is greater than the second value, upon detecting that the angle between the first housing structure 210 and the second housing structure 220 has changed to be greater than or equal to a designated size.

According to an example, the designated condition may include a condition where, when the electronic device 100 is implemented as a rollable housing, the distance between the first housing structure (e.g., the first housing structure 310 of FIG. 3A) and the second housing structure (e.g., the second housing structure 320 of FIG. 3A) is less than (or less than or equal to) a designated size. When the distance between the first housing structure 310 and the second housing structure 320 is less than (or less than or equal to) a designated size, the distance between antennas performing signal output through short-range wireless communication may decrease and the decrease in antenna distance may cause a degradation in the performance of short-range wireless communication.

The processor 520 may determine whether to activate the diversity transmission mode based at least in part on the quality of the signal received from the external electronic device being less than (or less than or equal to) a first value when the distance between the first housing structure 310 and the second housing structure 320 is less than (or less than or equal to) a designated size.

The processor 520 may determine to not activate the diversity transmission mode in the case that the quality of the signal received from the external electronic device is greater than or equal to (or greater than) a first value.

The processor 520 may identify whether the number of packets that failed to be transmitted to an external electronic device out of the packets it attempted to send is greater than or equal to (or greater than) a third value when the quality of the signal received from the external electronic device is less than (or less than or equal to) a first value.

The processor 520 may determine to activate the diversity transmission mode in the case that the number of packets that failed to be transmitted to an external electronic device out of the packets it attempted to send is greater than or equal to (or greater than) a third value. In addition, the processor 520 may determine not to activate the diversity transmission mode in the case that the number of packets that failed to be transmitted to an external electronic device out of the packets it attempted to send is less than (or less than or equal to) the third value.

The processor 520 may determine whether to activate the diversity transmission mode based at least in part on the quality of the signal received from the external electronic device being less than (or less than or equal to) a second value when the distance between the first housing structure 310 and the second housing structure 320 is greater than or equal to (or greater than) a designated size.

The processor 520 may determine to not activate the diversity transmission mode in the case that the quality of the signal received from the external electronic device is greater than or equal to (or greater than) a second value.

The processor 520 may identify whether the number of packets that failed to be transmitted to an external electronic device out of the packets it attempted to send is greater than or equal to (or greater than) a fourth value when the quality of the signal received from the external electronic device is less than (or less than or equal to) a second value.

The processor 520 may determine to activate the diversity transmission mode in the case that the number of packets that failed to be transmitted to an external electronic device out of the packets it attempted to send is greater than or equal to (or greater than) the fourth value. In addition, the processor 520 may determine to not activate the diversity transmission mode in the case that the number of packets that failed to be transmitted to an external electronic device out of the packets it attempted to send is less than (or less than or equal to) the fourth value.

According to an example, the designated condition may include a condition where the electronic device 100 has activated a mode (e.g., Tx backoff) that reduces signal output. In the case that the electronic device 100 activates a mode that reduces signal output, the reduction in signal output may cause a degradation in the performance of the short-range wireless communication.

The processor 520 may determine whether to activate the diversity transmission mode based at least in part on the quality of the signal received from the external electronic device being less than (or less than or equal to) a first value when the electronic device 100 has activated a mode (e.g., Tx backoff) that reduces the signal output.

The processor 520 may determine to not activate the diversity transmission mode in the case that the quality of the signal received from the external electronic device is greater than or equal to (or greater than) a first value.

The processor 520 may identify whether the number of packets that failed to be transmitted to an external electronic device out of the packets it attempted to send is greater than or equal to (or greater than) a third value when the quality of the signal received from the external electronic device is less than (or less than or equal to) a first value.

The processor 520 may determine to activate the diversity transmission mode in the case that the number of packets that failed to be transmitted to an external electronic device out of the packets it attempted to send is greater than or equal to (or greater than) a third value. In addition, the processor 520 may determine not to activate the diversity transmission mode in the case that the number of packets that failed to be transmitted to an external electronic device out of the packets it attempted to send is less than (or less than or equal to) the third value.

The processor 520 may determine whether to activate the diversity transmission mode based at least in part on the quality of the signal received from the external electronic device being less than (or less than or equal to) a second value, in the case that the electronic device 100 has deactivated a mode (e.g., Tx backoff) that reduces signal output.

The processor 520 may determine to not activate the diversity transmission mode in the case that the quality of the signal received from the external electronic device is greater than or equal to (or greater than) a second value.

The processor 520 may identify whether the number of packets that failed to be transmitted to an external electronic device out of the packets it attempted to send is greater than or equal to (or greater than) a fourth value when the quality of the signal received from the external electronic device is less than (or less than or equal to) a second value.

The processor 520 may determine to activate the diversity transmission mode in the case that the number of packets that failed to be transmitted to an external electronic device out of the packets it attempted to send is greater than or equal to (or greater than) the fourth value. In addition, the processor 520 may determine not to activate the diversity transmission mode in the case that the number of packets that failed to be transmitted to an external electronic device out of the packets it attempted to send is less than (or less than or equal to) the fourth value.

According to an example, the designated condition may include a condition where the electronic device 100 and the external electronic device are not in line of sight (LoS) (or a condition where the electronic device 100 and the external electronic device are in non line of sight (nLoS)). According to an example, the electronic device 100 may identify whether the electronic device 100 and the external electronic device are in nLoS based on channel estimation between the electronic device 100 and the external electronic device or based on the distance between the electronic device 100 and the external electronic device. In the case that the electronic device 100 and the external electronic device are in nLoS, performance degradation of the short-range wireless communication may occur.

The processor 520 may determine whether to activate a diversity transmission mode based at least in part on whether the quality of a signal received from the external electronic device is less than (or less than or equal to) a first value when the electronic device 100 and the external electronic device are in nLoS.

The processor 520 may determine to not activate the diversity transmission mode in the case that the quality of the signal received from the external electronic device is greater than or equal to (or greater than) a first value.

The processor 520 may identify whether the number of packets that failed to be transmitted to an external electronic device out of the packets it attempted to send is greater than or equal to (or greater than) a third value when the quality of the signal received from the external electronic device is less than (or less than or equal to) a first value.

The processor 520 may determine to activate diversity transmission mode in the case that the number of packets that failed to be transmitted to an external device out of the packets it attempted to send is greater than or equal to (or greater than) a third value. In addition, the processor 520 may determine not to activate the diversity transmission mode in the case that the number of packets that failed to be transmitted to an external electronic device out of the packets it attempted to send is less than (or less than or equal to) a third value.

The processor 520 may determine whether to activate the diversity transmission mode based at least in part on whether the quality of the signal received from the external electronic device is less than (or less than or equal to) a second value when the electronic device 100 and the external electronic device are not in nLoS (or when the electronic device 100 and the external electronic device are in LoS).

The processor 520 may determine to not activate the diversity transmission mode in the case that the quality of the signal received from the external electronic device is greater than or equal to (or greater than) a second value.

The processor 520 may identify whether the number of packets that failed to be transmitted to an external electronic device out of the packets it attempted to send is greater than or equal to (or greater than) a fourth value when the quality of the signal received from the external electronic device is less than (or less than or equal to) a second value.

The processor 520 may determine to activate the diversity transmission mode in the case that the number of packets that failed to be transmitted to an external electronic device out of the packets it attempted to send is greater than or equal to (or greater than) the fourth value. In addition, the processor 520 may determine to not activate the diversity transmission mode in the case that the number of packets that failed to be transmitted to an external electronic device out of the packets it attempted to send is less than (or less than or equal to) the fourth value.

According to an example, the designated condition may include a condition where the estimated throughput when operating in the diversity transmission mode is greater than or equal to the currently measured throughput while the electronic device 100 is performing a designated service. The designated service may include a latency-sensitive service (e.g., voice call or video call), a service requiring a high transmission success rate as a service requiring high reliability, and/or a service performed by an application designated by a user of the electronic device 100. According to one example, in the case that the estimated throughput when operating in diversity transmission mode is greater than or equal to the throughput measured by the service, switching to diversity transmission mode may be advantageous for the service performance.

The processor 520 may determine whether to activate the diversity transmission mode based at least in part on the quality of the signal received from the external electronic device being less than (or less than or equal to) a first value, in the case that the estimated throughput when operating in the diversity transmission mode is greater than or equal to the currently measured throughput.

The processor 520 may determine to not activate the diversity transmission mode in the case that the quality of the signal received from the external electronic device is greater than or equal to (or greater than) a first value.

The processor 520 may identify whether the number of packets that failed to be transmitted to an external electronic device out of the packets it attempted to send is greater than or equal to (or greater than) a third value when the quality of the signal received from the external electronic device is less than (or less than or equal to) a first value.

The processor 520 may determine to activate the diversity transmission mode in the case that the number of packets that failed to be transmitted to an external electronic device out of the packets it attempted to send is greater than or equal to (or greater than) a third value. In addition, the processor 520 may determine not to activate the diversity transmission mode in the case that the number of packets that failed to be transmitted to an external electronic device out of the packets it attempted to send is less than (or less than or equal to) the third value.

The processor 520 may determine whether to activate the diversity transmission mode based at least in part on the quality of the signal received from the external electronic device being less than (or less than or equal to) a second value, in the case that the estimated throughput when operating in the diversity transmission mode is less than (or less than or equal to) the currently measured throughput.

The processor 520 may determine to not activate the diversity transmission mode in the case that the quality of the signal received from the external electronic device is greater than or equal to (or greater than) a second value.

The processor 520 may identify whether the number of packets that failed to be transmitted to an external electronic device out of the packets it attempted to send is greater than or equal to (or greater than) a fourth value when the quality of the signal received from the external electronic device is less than (or less than or equal to) a second value.

The processor 520 may determine to activate the diversity transmission mode in the case that the number of packets that failed to be transmitted to an external electronic device out of the packets it attempted to send is greater than or equal to (or greater than) the fourth value. In addition, the processor 520 may determine to not activate the diversity transmission mode in the case that the number of packets that failed to be transmitted to an external electronic device out of the packets it attempted to send is less than (or less than or equal to) the fourth value.

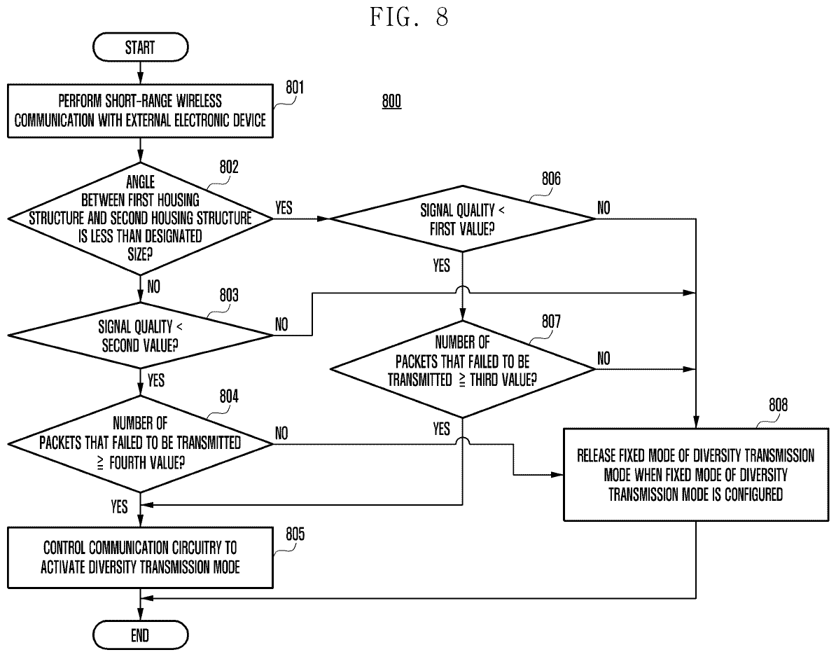

In relation to the above description, the flowcharts shown in FIGS. 8 to 12 below describe the above content in greater detail. It should be noted that the examples illustrated in FIGS. 8 to 12 are not exclusive from the example described in FIG. 5, and it should be noted that the examples illustrated in FIGS. 8 to 12 may be combined with each other.

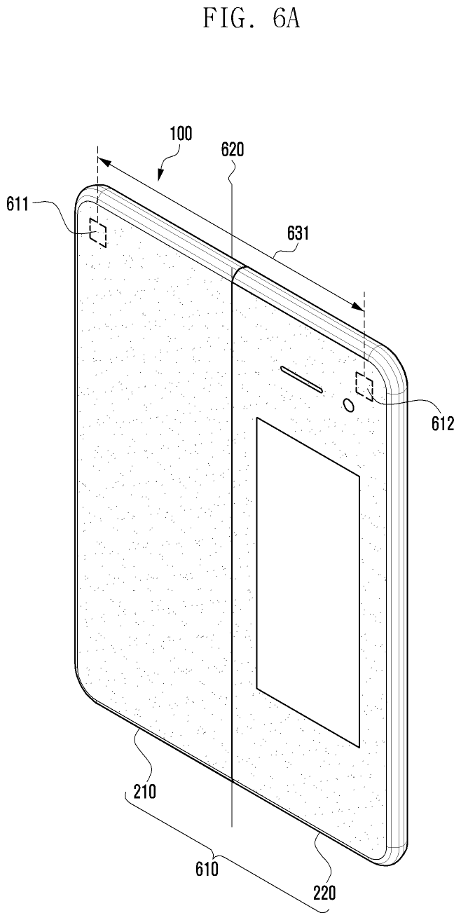

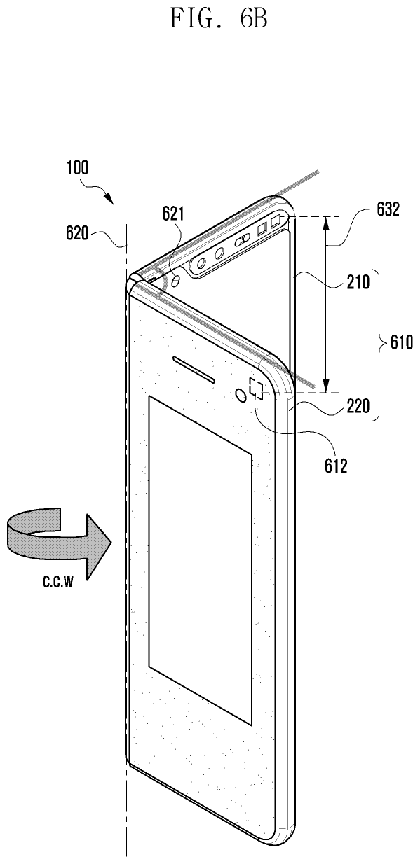

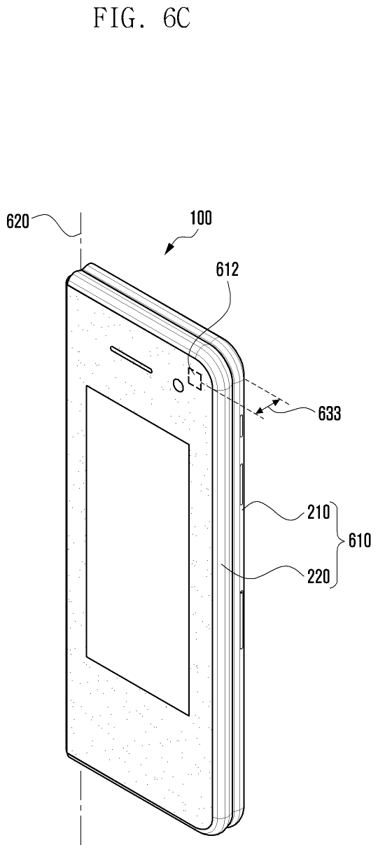

FIGS. 6A, 6B, and 6C are perspective views illustrating various examples of an electronic device determining whether to activate a diversity transmission mode based on the angle between a first housing structure and a second housing structure according to various embodiments.

FIGS. 6A, 6B, and 6C are perspective views illustrating various embodiments where an electronic device according to various embodiments changes the operation of short-range wireless communication based on changes in the angle between the first housing structure and the second housing structure.

With reference to FIG. 6A, an electronic device (e.g., the electronic device 100 of FIG. 5) may include a foldable housing 610 comprising a first housing 210 and a second housing 220.

According to various embodiments, the second housing 220 may be connected to the first housing 210 in a foldable manner. The first housing 210 and the second housing 220 may be foldable with respect to each other about a folding axis 620 (e.g., the folding axis (A-axis) of FIG. 2A) extending in a first direction. The first housing 210 and the second housing 220 may be disposed such that at least a portion of each faces the other when folded together.

With reference to FIG. 6A, the angle formed between the first housing 210 and the second housing 220 may be 180 degrees. When the angle formed by the first housing 210 and the second housing 220 is greater than or equal to a predetermined angle, the electronic device 300 may be defined as being in an unfolded state. The predetermined angle may be 180 degrees, but it may be changed according to the designer's intent. When the electronic device 200 is in the unfolded state, the first housing 210 and the second housing 220 may form a planar structure.

FIG. 6B is a diagram illustrating an electronic device 100 according to various embodiments being folded counterclockwise (C.C.W.) around a folding axis 620, and FIG. 6C is a diagram illustrating an electronic device 100 according to various embodiments being folded to its maximum extent around the folding axis 620 as the centerline.

With reference to FIGS. 6B and 6C, a user of the electronic device 100 may fold the foldable housing 610 of the unfolded electronic device 100 around the folding axis 620 by applying force to the electronic device 200.

The angle 621 between the first housing structure 210 and the second housing structure 220 may be the largest when the foldable housing 610 is fully unfolded (FIG. 6A) and may decrease as the foldable housing 610 is folded. The angle 621 may be smallest when the foldable housing 610 is fully folded (FIG. 6C).

The first antenna (e.g., the first antenna 611 of FIG. 6A) may be disposed inside the first housing 210, and the second antenna (e.g., the second antenna 612 of FIGS. 6A, 6B and 6C) may be disposed inside the second housing 220. The distance 631 between the first antenna 611 and the second antenna 612 may change depending on the folding (or unfolding) of the first housing 210 and the second housing 220 around the folding axis 620. The distance 631 may be the largest when the foldable housing 610 is fully unfolded (e.g., FIG. 6A) and may decrease as the foldable housing 610 is folded. When the foldable housing 610 is partially folded (e.g., FIG. 6B), the distance 632 between the first antenna 611 and the second antenna 612 may be smaller than the distance 631 when the foldable housing 610 is fully unfolded. When the foldable housing 610 is fully folded (e.g., FIG. 6C), the distance 633 between the first antenna 611 and the second antenna 612 may be smaller than the distance 632. That is, the distances 631, 632, and 633 may correlate with the angle 621.

The electronic device 100 may measure the angle between the first housing structure 210 and the second housing structure 220 based on the sensor and identify whether the angle satisfies designated conditions. The designated condition may refer to a condition related to the distance between the first antenna 611 and the second antenna 612. The distance between the first antenna 611 and the second antenna 612 may increase as the angle between the first housing structure 210 and the second housing structure 220 increases. The distance between the first antenna 611 and the second antenna 612 may decrease as the angle between the first housing structure 210 and the second housing structure 220 decreases.

The electronic device 100 may control the communication circuitry 510 to identify the quality of a signal received from an external electronic device according to a designated interval. The electronic device 100 may perform at least one operation to control the communication circuitry 510 based on the quality of the signal received from the external electronic device.

According to an example, the electronic device 100 may determine whether to switch the signal transmission mode of the communication circuitry 510 based on the quality of the signal received from the external electronic device. For example, the electronic device 100 may determine whether the communication circuitry 510 activates a diversity transmission mode based on whether the quality of the signal received from the external electronic device is less than (or less than or equal to) a designated level.

According to an example, the electronic device 100 may configure a value for comparison with the quality of the signal received from the external electronic device differently depending on whether the angle between the first housing structure 210 and the second housing structure 220 is less than (or less than or equal to) a designated size. In the case that the angle between the first housing structure 210 and the second housing structure 220 is less than (or less than or equal to) a designated size, the distance between antennas performing signal output through short-range wireless communication may decrease and the decrease in distance between antennas may cause a degradation in the performance of the short-range wireless communication.

The electronic device 100 may determine whether to activate the diversity transmission mode based at least in part on the quality of the signal received from the external electronic device being less than (or less than or equal to) a first value when the angle between the first housing structure 210 and the second housing structure 220 is less than (or less than or equal to) a designated size.

The electronic device 100 may determine to not activate the diversity transmission mode in the case that the quality of the signal received from the external electronic device is greater than or equal to (or greater than) a first value.

The electronic device 100 may identify whether the number of packets that failed to be transmitted to an external electronic device out of the packets it attempted to send is greater than or equal to (or greater than) a third value when the quality of the signal received from the external electronic device is less than (or less than or equal to) a first value.

The electronic device 100 may determine to activate the diversity transmission mode in the case that the number of packets that failed to be transmitted to an external electronic device out of the packets it attempted to send is greater than or equal to (or greater than) a third value. In addition, the electronic device 100 may determine not to activate the diversity transmission mode in the case that the number of packets that failed to be transmitted to an external electronic device out of the packets it attempted to send is less than (or less than or equal to) the third value.

Conversely, the electronic device 100 may determine whether to activate the diversity transmission mode based at least in part on the quality of the signal received from the external electronic device being less than (or less than or equal to) a second value when the angle between the first housing structure 210 and the second housing structure 220 is greater than or equal to (greater than) a designated size.

The electronic device 100 may determine to not activate the diversity transmission mode in the case that the quality of the signal received from the external electronic device is greater than or equal to (or greater than) a second value.

The electronic device 100 may identify whether the number of packets that failed to be transmitted to an external electronic device out of the packets it attempted to send is greater than or equal to (or greater than) a fourth value when the quality of the signal received from the external electronic device is less than (or less than or equal to) a second value.

The electronic device 100 may determine to activate the diversity transmission mode in the case that the number of packets that failed to be transmitted to an external electronic device out of the packets it attempted to send is greater than equal to (or greater than) a fourth value. In addition, the electronic device 100 may determine not to activate the diversity transmission mode in the case that the number of packets that failed to be transmitted to an external electronic device out of the packets it attempted to send is less than (or less than or equal to) the fourth value.

In the case that the electronic device 100 determines to activate the diversity transmission mode, the electronic device 100 may transmit a signal requesting activation of the diversity transmission mode to the communication circuitry 510. Upon receiving the signal requesting activation of the diversity transmission mode from the electronic device 100, the communication circuitry 510 may activate the diversity transmission mode. In the case that the electronic device 100 determines to activate the diversity transmission mode, the communication circuitry 510 may maintain the activation of the diversity transmission mode regardless of the quality of the signal received from the external electronic device. For example, the communication circuitry 510 may perform MCS level adjustment based on quality of the signal, but may prohibit performing the operation of switching from diversity transmission mode to spatial multiplexing mode.

In the case that the electronic device 100 determines to not activate the diversity transmission mode, the communication circuitry 510 may perform adjustment of the MCS level and/or switching of the signal transmission method based on the quality of the signal received from the external electronic device.

According to an example, the first value and the second value may be configured differently from each other. For example, the first value may be configured to be larger than the second value. In addition, the third value and the fourth value may be configured differently from each other. The third value may be configured to be smaller than the fourth value. The configurations may be to activate (or switch to) the diversity transmission mode more quickly when the electronic device 100 satisfies designated conditions.

Assuming a situation where the first value is configured to be larger than the second value, and a signal with a quality smaller than the first value but larger than the second value is received from an external electronic device, the electronic device 100 may control the communication circuitry 510 to activate the diversity transmission mode when the angle between the first housing structure 210 and the second housing structure 220 is less than (or less than or equal to) a designated size. In the case that the angle between the first housing structure 210 and the second housing structure 220 is greater than or equal to (or greater than) a designated size, the electronic device 100 may not switch the communication circuitry 510 to the diversity transmission mode, as it receives a signal from the external electronic device having a quality less than the first value but greater than the second value. For example, by configuring the value for comparison with the quality of the signal received from the external electronic device differently depending on whether the angle between the first housing structure 210 and the second housing structure 220 is less than (or less than or equal to) a designated size, the electronic device 100 may perform the switch to the diversity transmission mode more quickly as the quality of the signal received from the external electronic device degrades, thereby improving the transmission performance of short-range wireless communication.

In the case that the third value is configured to be smaller than the fourth value, the electronic device 100 may may control the communication circuitry 510 to activate the diversity transmission mode when the angle between the first housing structure 210 and the second housing structure 220 is less than (or less than or equal to) a designated size, and the number of packets that failed to be transmitted to an external electronic device is greater than the third value and less than the fourth value. The electronic device 100 may not perform the operation of the communication circuitry 510 activating the diversity transmission mode when the angle between the first housing structure 210 and the second housing structure 220 is greater than or equal to a designated size, and the number of packets that failed to be transmitted to an external electronic device is greater than a third value and less than a fourth value. For example, by configuring the value for comparison with the number of packets that failed to be transmitted to an external electronic device differently depending on whether the angle between the first housing structure 210 and the second housing structure 220 is less than (or less than or equal to) a designated size, the electronic device 100 may perform the switch to the diversity transmission mode more quickly as the quality of the signal received from the external electronic device degrades, thereby improving the transmission performance of short-range wireless communication.

The electronic device 100 may identify the quality of the signal received from the external electronic device when the angle between the first housing structure 210 and the second housing structure 220 is greater than or equal to a designated size. The electronic device 100 may not perform an operation to activate the diversity transmission mode in the case that the quality of the signal received from the external electronic device is less than a first value and greater than a second value. The electronic device 100 may not transmit a signal requesting activation of the diversity transmission mode to the communication circuitry 510. The electronic device 100 may transmit a signal requesting activation of the diversity transmission mode to the communication circuitry 510, considering that the quality of the signal is less than the first value, upon detecting that the angle between the first housing structure 210 and the second housing structure 220 has changed to less than (or less than or equal to) a designated size. The communication circuitry 510, upon receiving the signal requesting activation of the diversity transmission mode from the electronic device 100, may activate the diversity transmission mode.

The electronic device 100 may identify the quality of the signal received from the external electronic device when the angle between the first housing structure 210 and the second housing structure 220 is less than (or less than or equal to) a designated size. The electronic device 100 may activate the diversity transmission mode when the quality of the signal received from the external electronic device is less than a first value and greater than a second value. After activating the diversity transmission mode, the electronic device 100 may control the communication circuitry 510 to terminate maintaining the diversity transmission mode, considering that the quality of the signal is greater than the second value, upon detecting that the angle between the first housing structure 210 and the second housing structure 220 has changed to be greater than or equal to a designated size.

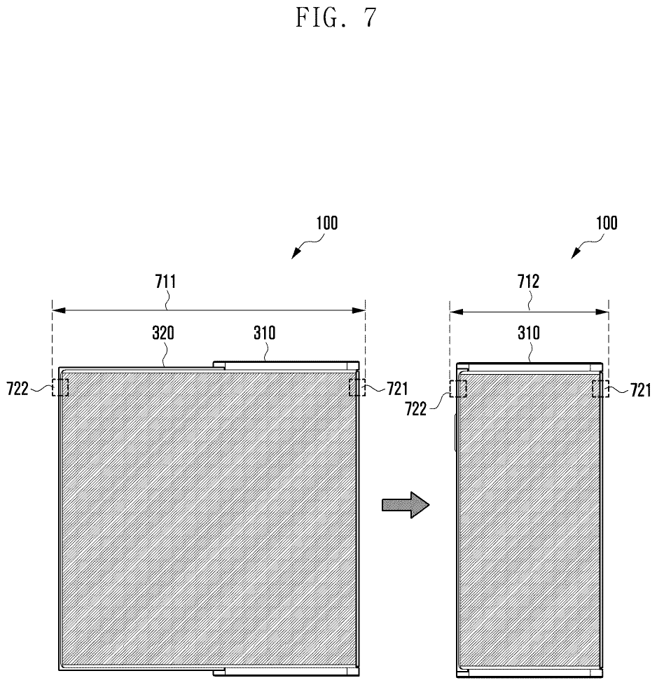

FIG. 7 is a diagram illustrating an example of an electronic device determining whether to activate a diversity transmission mode based on the length between the first housing structure and the second housing structure according to various embodiments.

The electronic device 100 may be implemented as a rollable housing (or, a slidable housing) wherein a first housing structure (e.g., the first housing 310 of FIG. 3A) and a second housing structure (e.g., the second housing 320 of FIG. 3A) are movably coupled within a designated direction and a designated distance. A first antenna 721 may be implemented inside the first housing structure 310, and a second antenna 722 may be implemented inside the second housing structure 320. The distance (or isolation) between the first antenna 721 and the second antenna 722 may change as the first housing structure 310 and the second housing structure 320 are slid in or slid out. For example, the distance between the first antenna 721 and the second antenna 722 may decrease when the first housing structure 310 and the second housing structure 320 are slid in. When the electronic device 100 is operating in STR mode (or transmitting or receiving data with a high MCS level) and the distance between the first housing structure 310 and the second housing structure 320 decreases, the STR mode of the electronic device 100 may not operate smoothly due to the reduced distance between the first antenna 721 and the second antenna 722.

The distance 711 between the first antenna 721 and the second antenna 722 may change as the second housing 320 is slid into the first housing 310 (or slid out to the outside). For example, the distance 711 between the first antenna 721 and the second antenna 722 when the second housing 320 is maximally slid out to the outside of the first housing 310 may be greater than the distance 722 between the first antenna 721 and the second antenna 722 when the second housing 320 is maximally slid into the interior of the first housing 310. That is, the distances 711 and 712 may correlate with the degree to which the second housing 320 is slid in (or slid out).

The electronic device 100 may control the communication circuitry 510 to identify the quality of a signal received from an external electronic device at designated intervals. The electronic device 100 may perform at least one operation to control the communication circuitry 510 based on the quality of the signal received from the external electronic device.

According to an example, the electronic device 100 may determine whether to switch the signal transmission mode of the communication circuitry 510 based on the quality of the signal received from the external electronic device. For example, the electronic device 100 may determine whether the communication circuitry 510 activates a diversity transmission mode based on whether the quality of the signal received from the external electronic device is less than (or less than or equal to) a designated level.

According to an example, the electronic device 100 may configure a value for comparison with the quality of the signal received from the external electronic device differently depending on whether the distance between the first housing structure 310 and the second housing structure 320 is less than (or less than or equal to) a designated size. In the case that the distance between the first housing structure 310 and the second housing structure 320 is less than (or less than or equal to) a designated size, the distance between antennas performing signal output through short-range wireless communication may decrease, and the decrease in distance between antennas may cause a degradation in the performance of the short-range wireless communication.

The electronic device 100 may determine whether to activate the diversity transmission mode based at least in part on the quality of the signal received from the external electronic device being less than (or less than or equal to a first value) when the distance between the first housing structure 310 and the second housing structure 320 is less than (or less than or equal to) a designated size.

The electronic device 100 may determine to not activate the diversity transmission mode in the case that the quality of the signal received from the external electronic device is greater than or equal to (or greater than) a first value.

The electronic device 100 may determine whether the number of packets that failed to be transmitted to an external electronic device out of the packets it attempted to send is greater than or equal to (or greater than) a third value when the quality of the signal received from the external electronic device is less than (or less than or equal to) a first value.

The electronic device 100 may determine to activate the diversity transmission mode in the case that the number of packets that failed to be transmitted to an external electronic device out of the packets it attempted to send is greater than or equal to (or greater than) a third value. In addition, the electronic device 100 may determine not to activate the diversity transmission mode in the case that the number of packets that failed to be transmitted to an external electronic device out of the packets it attempted to send is less than (or less than or equal to) the third value.

Conversely, the electronic device 100 may determine whether to activate the diversity transmission mode based at least in part on the quality of the signal received from the external electronic device being less than (or less than or equal) to a second value when the distance between the first housing structure 310 and the second housing structure 320 is greater than or equal to (or greater than) a designated size.

The electronic device 100 may determine to not activate the diversity transmission mode in the case that the quality of the signal received from the external electronic device is greater than or equal to (or greater than) a second value.

The electronic device 100 may identify whether the number of packets that failed to be transmitted to an external electronic device out of the packets it attempted to send is greater than or equal to (or greater than) a fourth value when the quality of the signal received from the external electronic device is less than (or less than or equal to) a second value.

The electronic device 100 may determine to activate a diversity transmission mode in the case that the number of packets that failed to be transmitted to an external electronic device out of the packets it attempted to send is greater than or equal to (or greater than) the fourth value. In addition, the electronic device 100 may determine not to activate the diversity transmission mode in the case that the number of packets that failed to be transmitted to an external electronic device out of the packets it attempted to send is less than (or less than or equal to) the fourth value.

FIG. 8 is a flowchart 800 illustrating an example operation of an electronic device for determining whether to activate a diversity transmission mode based on the angle between the first housing structure and the second housing structure according to various embodiments.

The electronic device (e.g., the electronic device 100 of FIG. 5) may perform short-range wireless communication with an external electronic device in operation 801.

The electronic device 100 may control the communication circuitry 510 to broadcast a probe request message to search for the external electronic device. The probe request message may include information about the electronic device 100. For example, the probe request message may include various identification information (e.g., MAC address) that distinguishes the electronic device 100 from other electronic devices and performance information related to short-range wireless communication of the electronic device 100. Upon receiving the probe request message, the external electronic device may transmit a probe response message corresponding to the probe request message to the electronic device 100. Upon receiving the probe response message, the electronic device 100 may successfully complete the searching of the external electronic device.

Upon discovering the external electronic device, the electronic device 100 may perform an authentication procedure, an association procedure, and/or a security setup procedure with the external electronic device. Upon completion of the aforementioned procedures, the electronic device 100 may complete a connection with the external electronic device through short-range wireless communication.

The electronic device 100 may complete a connection with the external electronic device through short-range wireless communication and may perform short-range wireless communication with the external electronic device. The electronic device 100 may receive signals from the external electronic device as it performs short-range wireless communication with the external electronic device. According to an example, the signal received from the external electronic device may be a signal containing at least a portion of user data related to performing a service using the short-range wireless communication, or it may be a signal related to configuring the short-range wireless communication (e.g., a beacon signal).

In operation 802, the electronic device 100 may identify whether the angle between the first housing structure (e.g., the first housing structure 210 of FIG. 2A) and the second housing structure (e.g., the second housing structure 220 of FIG. 2A) is less than a designated size.

In the case that the angle between the first housing structure 210 and the second housing structure 220 is less than (or less than or equal to) a designated size, the distance between antennas performing signal output through short-range wireless communication may decrease and the decrease in distance between antennas may cause a degradation in the performance of the short-range wireless communication.

In operation 803, the electronic device 100 may identify whether the quality of the signal received from the external electronic device is less than a second value when the angle between the first housing structure 210 and the second housing structure 220 is greater than or equal to a designated size (operation 802-N).

The electronic device 100 may determine whether to activate the diversity transmission mode based at least in part on whether the quality of the signal received from the external electronic device is less than (or less than or equal to) a second value when the angle between the first housing structure 210 and the second housing structure 220 is greater than or equal to (or greater than) a designated size.

The electronic device 100 may determine to not activate the diversity transmission mode in the case that the quality of the signal received from the external electronic device is greater than or equal to (or greater than) a second value.

In operation 804, the electronic device 100 may identify whether the number of packets that failed to be transmitted to an external electronic device is greater than or equal to a fourth value, in the case that the quality of the signal received from the external electronic device is less than a second value (operation 803-Y).

The electronic device 100 may identify whether the number of packets that failed to be transmitted to an external electronic device out of the packets it attempted to send is greater than or equal to (or greater than) a fourth value when the quality of the signal received from the external electronic device is less than (or less than or equal to) a second value.

The electronic device 100 may control the communication circuitry (e.g., the communication circuitry 510 of FIG. 5) to activate the diversity transmission mode in operation 805 in the case that the number of packets that failed to be transmitted to an external electronic device is greater than or equal to the fourth value (operation 804-Y).

In the case that the electronic device 100 determines to activate the diversity transmission mode, the electronic device 100 may transmit a signal requesting activation of the diversity transmission mode to the communication circuitry 510. Upon receiving the signal requesting activation of the diversity transmission mode from the electronic device 100, the communication circuitry 510 may activate the diversity transmission mode. In the case that the electronic device 100 determines to activate the diversity transmission mode, the communication circuitry 510 may maintain the activation of the diversity transmission mode regardless of the quality of the signal received from the external electronic device. For example, the communication circuitry 510 may perform MCS level adjustment based on quality of the signal, but may prohibit performing the operation of switching from diversity transmission mode to spatial multiplexing mode.

In operation 806, the electronic device 100 may identify whether the quality of the signal received from the external electronic device is less than a first value when the angle between the first housing structure 210 and the second housing structure 220 is less than a designated size (operation 802-Y).

The electronic device 100 may determine whether to activate the diversity transmission mode based at least in part on whether the quality of the signal received from the external electronic device is less than (or less than or equal to) a first value when the angle between the first housing structure 210 and the second housing structure 220 is less than (or less than or equal to) a designated size.

According to an example, the first value and the second value may be configured differently. For example, the first value may be configured to be larger than the second value. The configuration may be to activate (or switch to) the diversity transmission mode more quickly when the electronic device 100 satisfies the designated condition.

In the case that the first value is configured to be larger than the second value, and a signal with a quality smaller than the first value but larger than the second value is received from an external electronic device, the electronic device 100 may control the communication circuitry 510 to activate the diversity transmission mode when the angle between the first housing structure 210 and the second housing structure 220 is less than (or less than or equal to) a designated size. The electronic device 100 may not switch the communication circuitry 510 to the diversity transmission mode, as it receives a signal from the external electronic device having a quality less than the first value but greater than the second value, in the case that the angle between the first housing structure 210 and the second housing structure 220 is greater than (or greater than or equal to) a designated size. For example, by configuring a value for comparison with the quality of the signal received from the external electronic device differently depending on whether the angle between the first housing structure 210 and the second housing structure 220 is less than (or less than or equal to) a designated size, the electronic device 100 may perform the switch to the diversity transmission mode more quickly as the quality of the signal received from the external electronic device degrades, thereby improving the transmission performance of short-range wireless communication.

In operation 807, the electronic device 100 may identify whether the number of packets that failed to be transmitted to an external electronic device is greater than or equal to a third value when the quality of the signal received from the external electronic device is less than a first value (operation 806-Y).

The third value and the fourth value may be configured differently. The third value may be configured to be smaller than the fourth value. The configuration may be to activate (or switch to) the diversity transmission mode more quickly when the electronic device 100 satisfies designated conditions.

In the case that the third value is configured to be smaller than the fourth value, the electronic device 100 may activate (or switch to) the diversity transmission mode more quickly when the angle between the first housing structure 210 and the second housing structure 220 is less than (or less than or equal to) a designated size and the number of packets that failed to be transmitted to an external electronic device is greater than the third value and less than the fourth value, the electronic device 100 may control the communication circuitry 510 to activate the diversity transmission mode. Conversely, the electronic device 100 may not perform the operation of the communication circuitry 510 activating the diversity transmission mode when the angle between the first housing structure 210 and the second housing structure 220 is greater than or equal to a designated size, and the number of packets that failed to be transmitted to an external electronic device is greater than a third value and less than a fourth value. That is, by configuring the value for comparison with the number of packets that failed to be transmitted to an external electronic device differently depending on whether the angle between the first housing structure 210 and the second housing structure 220 is less than (or less than or equal to) a designated size, the electronic device 100 may perform the switch to the diversity transmission mode more quickly as the quality of the signal received from the external electronic device degrades, thereby improving the transmission performance of short-range wireless communication.

The electronic device 100 may identify whether the number of packets that failed to be transmitted to an external electronic device out of the packets it attempted to send is greater than or equal to (or greater than) a third value when the quality of the signal received from the external electronic device is less than (or less than or equal to) a first value.

The electronic device 100 may determine to activate the diversity transmission mode in the case that the number of packets that failed to be transmitted to an external electronic device out of the packets it attempted to send is greater than or equal to (or greater than) the third value.

In addition, the electronic device 100 may determine not to activate the diversity transmission mode in the case that the number of packets that failed to be transmitted to an external electronic device out of the packets it attempted to send is less than (or less than or equal to) a third value.

The electronic device 100 may control the communication circuitry 510 to activate the diversity transmission mode in operation 805 in the case that the number of packets that failed to be transmitted to an external electronic device is greater than or equal to the third value (operation 807-Y).

The electronic device 100 may release the fixed mode of the diversity transmission mode, when the fixed mode of the diversity transmission mode is configured, in operation 808, in the case that the quality of the signal is not less than a second value (operation 803-N), the quality of the signal is not less than a first value (operation 806-N), the number of packets that failed to be transmitted is not greater than or equal to a third value (operation 807-N), and/or the number of packets that failed to be transmitted is not greater than or equal to a fourth value (operation 804-N).

The fixed mode of the diversity transmission mode may refer to the communication circuitry 510 maintaining the diversity transmission mode regardless of the quality of the signal received from the external electronic device.

Upon the electronic device 100 releasing the fixed mode of the diversity transmission mode, the communication circuitry 510 may perform adjustment of the MCS level and/or switching of the signal transmission method based on the quality of the signal received from the external electronic device.

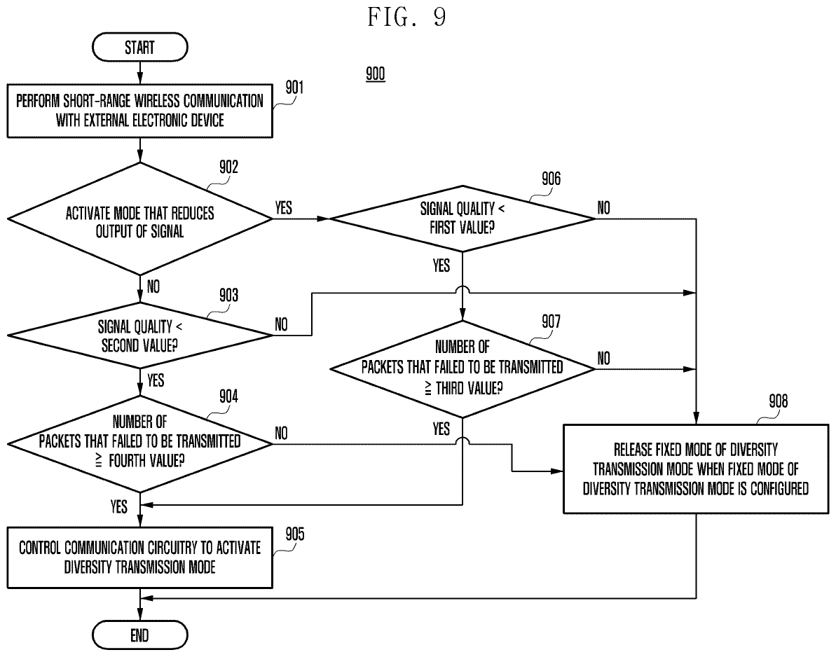

FIG. 9 is a flowchart 900 illustrating an example operation of an electronic device for determining whether to activate a diversity transmission mode based on whether the mode that reduces the output of the signal through short-range wireless communication (Tx backoff mode) is activated according to various embodiments.

The electronic device (e.g., the electronic device 100 of FIG. 5) may perform short-range wireless communication with an external electronic device in operation 901.

The electronic device 100 may control a communication circuitry 510 to search for an external electronic device to be connected through short-range wireless communication.

The electronic device 100 may control the communication circuitry 510 to broadcast a probe request message to search for the external electronic device. The probe request message may include information about the electronic device 100. For example, the probe request message may include various identification information (e.g., MAC address) that distinguishes the electronic device 100 from other electronic devices and performance information related to short-range wireless communication of the electronic device 100. Upon receiving the probe request message, the external electronic device may transmit a probe response message corresponding to the probe request message to the electronic device 100. Upon receiving the probe response message, the electronic device 100 may successfully complete the discovery of the external electronic device.

Upon discovering the external electronic device, the electronic device 100 may perform an authentication procedure, an association procedure, and/or a security setup procedure with the external electronic device. Upon completion of the aforementioned procedures, the electronic device 100 may complete a connection with the external electronic device through short-range wireless communication.

The electronic device 100 may complete the connection with the external electronic device through short-range wireless communication and perform short-range wireless communication with the external electronic device. As the electronic device 100 performs short-range wireless communication with the external electronic device, it may receive signals from the external electronic device. According to one example, the signal received from the external electronic device may be a signal containing at least a portion of user data related to the performance of a service using short-range wireless communication, or it may be a signal related to configuring short-range wireless communication (e.g., a beacon signal).

The electronic device 100 may control the communication circuitry 510 to identify the quality of the signal received from the external electronic device according to a designated interval. The electronic device 100 may perform at least one operation controlling the communication circuitry 510 based on the quality of the signal received from the external electronic device.

In operation 902, the electronic device 100 may determine whether the electronic device 100 has activated a mode (e.g., Tx backoff) that reduces signal output.

In the case that the electronic device 100 has activated a mode that reduces signal output, the reduction in signal output may cause a degradation in the performance of short-range wireless communication.

In operation 903, in the case that the electronic device 100 has deactivated a mode (e.g., Tx backoff) that reduces signal output (operation 902-N), the electronic device 100 may identify whether the quality of the signal received from the external electronic device is less than a second value.

The electronic device 100 may determine whether to activate the diversity transmission mode based at least in part on whether the quality of the signal received from the external electronic device is less than the second value, in the case that the electronic device 100 has deactivated a mode (e.g., Tx backoff) that reduces signal output.

The electronic device 100 may determine not to activate the diversity transmission mode in the case that the quality of the signal received from the external electronic device is greater than or equal to (or greater than) a second value.

In operation 904, the electronic device 100 may identify whether the number of packets that failed to be transmitted to an external electronic device is greater than or equal to a fourth value, in the case that the quality of the signal received from the external electronic device is less than a second value (operation 903-Y).

The electronic device 100 may identify whether the number of packets that failed to be transmitted to an external electronic device out of the packets it attempted to send is greater than or equal to (or greater than) a fourth value when the quality of the signal received from the external electronic device is less than (or less than or equal to) a second value.

The electronic device 100 may control the communication circuitry (e.g., the communication circuitry 510 of FIG. 5) to activate the diversity transmission mode in operation 905 in the case that the number of packets that failed to be transmitted to an external electronic device is greater than or equal to the fourth value (operation 904-Y).

The electronic device 100 may determine to activate the diversity transmission mode in the case that the number of packets that failed to be transmitted to an external electronic device out of the packets it attempted to send is greater than or equal to (or greater than) the fourth value. In addition, the electronic device 100 may determine not to activate the diversity transmission mode in the case that the number of packets that failed to be transmitted to an external electronic device out of the packets it attempted to send is less than (or less than or equal to) the fourth value.

In operation 906, the electronic device 100 may identify whether the quality of the signal received from the external electronic device is less than a first value in the case that the electronic device 100 has activated a mode (e.g., Tx backoff) that reduces signal output (operation 902-Y).

According to an example, the first value and the second value may be configured differently. For example, the first value may be configured to be larger than the second value. The configuration may be to activate (or switch to) diversity transmission mode more quickly when the electronic device 100 satisfies designated conditions.

In the case that the first value is configured to be larger than the second value and a signal with a quality less than the first value but greater than the second value is received from an external electronic device, the electronic device 100 may control the communication circuitry 510 to activate the diversity transmission mode when the electronic device 100 has activated a mode (e.g., Tx backoff) that reduces the signal output. In the case that the electronic device 100 has deactivated a mode (e.g., Tx backoff) that reduces the signal output, the electronic device 100 may not switch the communication circuitry 510 to the diversity transmission mode upon receiving a signal from the external electronic device having a quality less than the first value but greater than the second value. For example, by configuring the value for comparison with the quality of the signal received from the external electronic device differently depending on whether the electronic device 100 has activated a mode (e.g., Tx backoff) that reduces signal output, the electronic device 100 may switch to diversity transmission mode more quickly as the quality of the signal received from the external electronic device degrades, thereby improving the transmission performance of short-range wireless communication.

The electronic device 100 may determine whether to activate the diversity transmission mode based at least in part on the quality of the signal received from the external electronic device being less than a first value, when the electronic device 100 has activated a mode (e.g., Tx backoff) that reduces the signal output.

The electronic device 100 may determine not to activate the diversity transmission mode in the case that the quality of the signal received from the external electronic device is greater than or equal to (or greater than) a first value (operation 906-N).

In operation 907, the electronic device 100 may identify whether the number of packets that failed to be transmitted to an external electronic device is greater than or equal to a third value, in the case that the quality of the signal received from the external electronic device is less than a first value (operation 906-Y).

The third value and the fourth value may be configured differently. The third value may be configured to be smaller than the fourth value. The configuration may be to activate (or switch to) the diversity transmission mode more quickly when the electronic device 100 satisfies the designated conditions.

In the case that the third value is configured to be smaller than the fourth value, the electronic device 100 may activate a mode (e.g., Tx backoff) to reduce the output of the signal and in the case that the number of packets that failed to be transmitted to an external electronic device is greater than the third value and less than the fourth value, the communication circuitry 510 may control the communication circuitry 510 to activate a diversity transmission mode. Conversely, in the case that the electronic device 100 deactivates the mode (e.g., Tx backoff) in which the electronic device 100 reduces the signal output and in the case that the number of packets that failed to be transmitted to an external electronic device is greater than a third value and less than a fourth value, the electronic device 100 may not perform the operation of activating the diversity transmission mode by the communication circuitry 510. That is, by configuring the value for comparison with the number of packets that failed to be transmitted to an external electronic device differently depending on whether the electronic device 100 activates a mode (e.g., Tx backoff) that reduces signal output, the electronic device 100 may switch to diversity transmission mode more quickly as the quality of the signal received from the external electronic device degrades, thereby improving the transmission performance of short-range wireless communication.

The electronic device 100 may identify whether the number of packets that failed to be transmitted to an external electronic device out of the packets it attempted to send is greater than or equal (or greater than) to a third value when the quality of the signal received from the external electronic device is less than (or less than or equal to) a first value.

The electronic device 100 may determine to activate the diversity transmission mode in the case that the number of packets that failed to be transmitted to an external electronic device out of the packets it attempted to send is greater than or equal to (or greater than) a third value (operation 907-N). In addition, the electronic device 100 may determine not to activate the diversity transmission mode in the case that the number of packets that failed to be transmitted to an external electronic device out of the packets it attempted to send is less than (or less than or equal to) the third value.

The electronic device 100 may control the communication circuitry 510 to activate the diversity transmission mode in the case that the number of packets that failed to be transmitted to an external electronic device is greater than or equal to the third value (operation 907-Y).

The electronic device 100 may release the fixed mode of the diversity transmission mode, when the fixed mode of the diversity transmission mode is configured, in operation 908, in the case that the quality of the signal is not less than a second value (operation 903-N), the quality of the signal is not less than a first value (operation 906-N), the number of packets that failed to be transmitted is not greater than or equal to a third value (operation 907-N), and/or the number of packets that failed to be transmitted is not greater than or equal to a fourth value (operation 904-N).

The fixed mode of the diversity transmission mode may refer to the communication circuitry 510 maintaining the diversity transmission mode regardless of the quality of the signal received from the external electronic device.

Upon the electronic device 100 releasing the fixed mode of the diversity transmission mode, the communication circuitry 510 may perform adjustment of the MCS level and/or switching of the signal transmission method based on the quality of the signal received from the external electronic device.

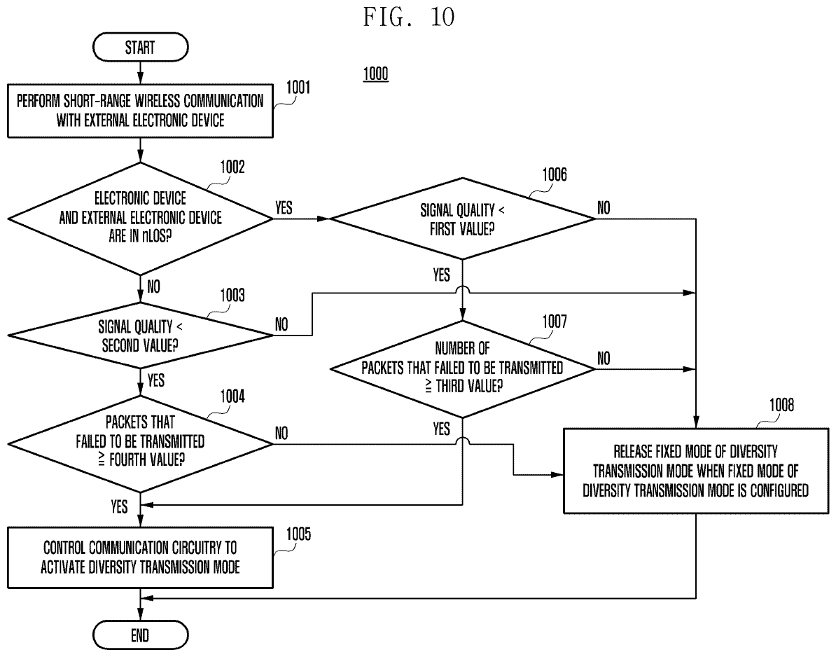

FIG. 10 is a flowchart 1000 illustrating an example operation of an electronic device for determining whether to activate a diversity transmission mode based on whether the electronic device and the external electronic device are in LoS according to various embodiments.

The electronic device (e.g., the electronic device 100 of FIG. 5) may perform short-range wireless communication with the external electronic device in operation 1001.

The electronic device 100 may control the communication circuitry 510 to broadcast a probe request message to search for the external electronic device. The probe request message may include information about the electronic device 100. For example, the probe request message may include various identification information (e.g., MAC address) that distinguishes the electronic device 100 from other electronic devices and performance information related to short-range wireless communication of the electronic device 100. Upon receiving the probe request message, the external electronic device may transmit a probe response message corresponding to the probe request message to the electronic device 100. Upon receiving the probe response message, the electronic device 100 may successfully complete the discovery of the external electronic device.

Upon discovering the external electronic device, the electronic device 100 may perform an authentication procedure, an association procedure, and/or a security setup procedure with the external electronic device. Upon completion of the aforementioned procedures, the electronic device 100 may complete a connection with the external electronic device through short-range wireless communication.

The electronic device 100 may complete the connection with the external electronic device through short-range wireless communication and perform short-range wireless communication with the external electronic device. As the electronic device 100 performs short-range wireless communication with the external electronic device, it may receive signals from the external electronic device. According to one example, the signal received from the external electronic device may be a signal containing at least a portion of user data related to performing a service using the short-range wireless communication, or it may be a signal related to configuring the short-range wireless communication (e.g., a beacon signal).

In operation 1002, the electronic device 100 may identify whether the external electronic device and the electronic device 100 are in non line of sight (nLoS).

According to an example, the electronic device 100 may identify whether the electronic device 100 and the external electronic device are in nLoS based on channel estimation between the electronic device 100 and the external electronic device or based on the distance between the electronic device 100 and the external electronic device. In the case that the electronic device 100 and the external electronic device are in nLoS, performance degradation of the short-range wireless communication may occur.

In operation 1003, the electronic device 100 may identify whether the quality of the signal received from the external electronic device is less than a second value when the electronic device 100 and the external electronic device are in LoS (operation 1002-N).

The electronic device 100 may determine whether to activate the diversity transmission mode based at least in part on whether the quality of the signal received from the external electronic device is less than (or less than or equal to) a second value when the electronic device 100 and the external electronic device are not in nLoS (or when the electronic device 100 and the external electronic device are in LoS).

The electronic device 100 may determine not to activate the diversity transmission mode in the case that the quality of the signal received from the external electronic device is greater than or equal to (or greater than) a second value.

In operation 1004, the electronic device 100 may identify whether the number of packets that failed to be transmitted to an external electronic device is greater than or equal to a fourth value, in the case that the quality of the signal received from the external electronic device is less than a second value (operation 1003-Y).

The electronic device 100 may identify whether the number of packets that failed to be transmitted to an external electronic device out of the packets it attempted to send is greater than or equal to (or greater than) a fourth value when the quality of the signal received from the external electronic device is less than a second value.

The electronic device 100 may determine to activate a diversity transmission mode in the case that the number of packets that failed to be transmitted to an external electronic device out of the packets it attempted to send is greater than or equal to (or greater than) the fourth value. In addition, the electronic device 100 may determine not to activate the diversity transmission mode in the case that the number of packets that failed to be transmitted to an external electronic device out of the packets it attempted to send is less than (less than or equal to) the fourth value.

In operation 1005, the electronic device 100 may control the communication circuitry (e.g., the communication circuitry 510 of FIG. 5) to activate the diversity transmission mode in the case that the number of packets that failed to be transmitted to an external electronic device is greater than or equal to the fourth value (operation 1004-Y).

In operation 1006, the electronic device 100 may identify whether the quality of the signal received from the external electronic device is less than a first value when the electronic device 100 and the external electronic device are in nLoS (operation 1002-Y).

The electronic device 100 may determine whether to activate a diversity transmission mode based at least in part on the quality of a signal received from an external electronic device being less than (or less than or equal to) a first value when the electronic device 100 and the external electronic device are in nLoS.

According to an example, the first value and the second value may be configured differently. For example, the first value may be configured to be larger than the second value. The configuration may be to activate (or switch to) the diversity transmission mode more quickly when the electronic device 100 satisfies designated conditions.

In the case that the first value is configured to be larger than the second value, and a signal having a quality smaller than the first value but larger than the second value is received from the external electronic device, the electronic device 100 may control the communication circuitry 510 to activate the diversity transmission mode when the electronic device 100 and the external electronic device are in nLoS. The electronic device 100 may not switch the communication circuitry 510 to the diversity transmission mode when it receives a signal from the external electronic device having a quality that is less than the first value but greater than the second value, in the case that the electronic device 100 and the external electronic device are in LoS. That is, by configuring the value for comparison with the quality of the signal received from the external electronic device differently depending on whether the electronic device 100 and the external electronic device are in LoS or nLoS, the electronic device 100 may perform the transition to the diversity transmission mode more quickly as the quality of the signal received from the external electronic device degrades, thereby improving the transmission performance of short-range wireless communication.

The electronic device 100 may determine not to activate the diversity transmission mode in the case that the quality of the signal received from the external electronic device is greater than or equal to (or greater than) a first value.

In operation 1007, the electronic device 100 may identify whether the number of packets that failed to be transmitted to an external electronic device is greater than or equal to a third value when the quality of the signal received from the external electronic device is less than a first value (operation 1006-Y).

The third value and the fourth value may be configured differently. The third value may be configured to be smaller than the fourth value. The configuration may be to activate (or switch to) diversity transmission mode more quickly when the electronic device 100 satisfies designated conditions.

The electronic device 100 may control the communication circuitry 510 to activate the diversity transmission mode when the electronic device 100 and the external electronic device are in nLoS, and the number of packets that failed to be transmitted to an external electronic device is greater than the third value and less than the fourth value. The electronic device 100 may not cause the communication circuitry 510 to perform the operation of activating the diversity transmission mode when the electronic device 100 and the external electronic device are in LoS, and the number of packets that failed to be transmitted to an external electronic device is greater than a third value and less than a fourth value. For example, by configuring the value for comparison with the number of packets that failed to be transmitted to an external electronic device differently depending on whether the electronic device 100 and the external electronic device are in LoS or nLoS, the electronic device 100 may perform the transition to the diversity transmission mode more quickly as the quality of the signal received from the external electronic device deteriorates, thereby improving the transmission performance of short-range wireless communication.

The electronic device 100 may identify whether the number of packets that failed to be transmitted to an external electronic device out of the packets it attempted to send is greater than or equal to (or greater than) a third value when the quality of the signal received from the external electronic device is less than (or less than or equal to) a first value.

The electronic device 100 may determine to activate a diversity transmission mode in the case that the number of packets that failed to be transmitted to an external electronic device out of the packets it attempted to send is greater than or equal to (or greater than) a third value. In addition, the electronic device 100 may determine not to activate the diversity transmission mode in the case that the number of packets that failed to be transmitted to an external electronic device out of the packets it attempted to send is less than (or less than or equal to) the third value.

The electronic device 100 may control the communication circuitry 510 to activate the diversity transmission mode in the case that the number of packets that failed to be transmitted to an external electronic device is greater than or equal to the third value (operation 1007-Y).

The electronic device 100 may release the fixed mode of the diversity transmission mode, in operation 1008, when the fixed mode of the diversity transmission mode is configured, in the case that the quality of the signal is not less than a second value (operation 1003-N), the quality of the signal is not less than a first value (operation 1006-N), the number of packets that failed to be transmitted is not greater than or equal to a third value (Operation 1007-N), and/or the number of packets that failed to be transmitted is not greater than or equal to a fourth value (operation 1004-N).

The fixed mode of the diversity transmission mode may refer to the communication circuitry 510 maintaining the diversity transmission mode regardless of the quality of the signal received from the external electronic device.

As the electronic device 100 releases the fixed mode of the diversity transmission mode, the communication circuitry 510 may perform adjustment of the MCS level and/or switching of the signal transmission method based on the quality of the signal received from the external electronic device.

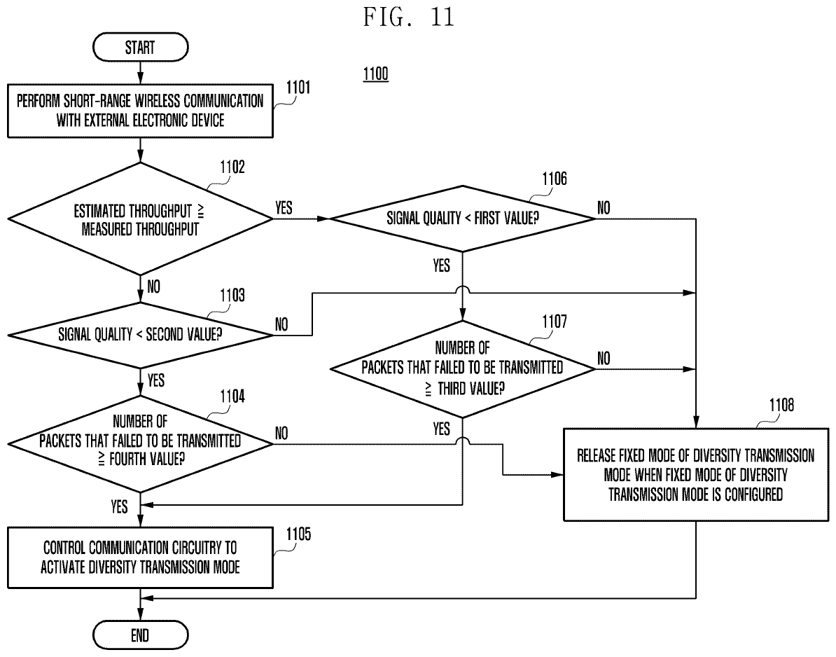

FIG. 11 is a flowchart 1100 illustrating an example operation of an electronic device for determining whether to activate a diversity transmission mode based on the comparison result of the expected throughput and the currently measured throughput when the electronic device operates in a diversity transmission mode according to various embodiments.

The electronic device (e.g., the electronic device 100 of FIG. 5) may, in operation 1101, perform short-range wireless communication with an external electronic device.

The electronic device 100 may control the communication circuitry 510 to broadcast a probe request message to search for the external electronic device. The probe request message may include information about the electronic device 100. For example, the probe request message may include various identification information (e.g., MAC address) that distinguishes the electronic device 100 from other electronic devices and performance information related to short-range wireless communication of the electronic device 100. Upon receiving the probe request message, the external electronic device may transmit a probe response message corresponding to the probe request message to the electronic device 100. Upon receiving the probe response message, the electronic device 100 may successfully complete the discovery of the external electronic device.

Upon discovering the external electronic device, the electronic device 100 may perform an authentication procedure, an association procedure, and/or a security setup procedure with the external electronic device. Upon completion of the aforementioned procedures, the electronic device 100 may complete a connection with the external electronic device through short-range wireless communication.

The electronic device 100 may complete the connection with the external electronic device through short-range wireless communication and perform short-range wireless communication with the external electronic device. As the electronic device 100 performs short-range wireless communication with the external electronic device, it may receive signals from the external electronic device. According to one example, the signal received from the external electronic device may be a signal containing at least a portion of user data related to the performance of a service using short-range wireless communication, or it may be a signal related to the configuration of short-range wireless communication (e.g., a beacon signal).

In operation 1102, the electronic device 100 may compare the estimated throughput in the diversity transmission mode with the measured throughput.

The electronic device 100 may identify whether the estimated throughput when operating in the diversity transmission mode is greater than or equal to the currently measured throughput while performing a designated service.

The designated service may include a latency-sensitive service (e.g., voice call or video call), a service requiring high reliability, a service requiring a high transmission success rate, and/or a service performed by an application designated by a user of the electronic device 100. According to an example, in the case that the estimated throughput when operating in diversity transmission mode is greater than or equal to the measured throughput of the service, switching to diversity transmission mode may be advantageous for the service performance.

In operation 1103, the electronic device 100 may identify whether the quality of the signal received from the external electronic device is less than (or less than or equal to) a second value in the case that the estimated throughput when operating in diversity transmission mode is less than the currently measured throughput (operation 1102-N).

The electronic device 100 may determine whether to activate the diversity transmission mode based at least in part on whether the quality of the signal received from the external electronic device is less than a second value, in the case that the estimated throughput when operating in the diversity transmission mode is less than (or less than or equal to) the currently measured throughput.

The electronic device 100 may determine not to activate the diversity transmission mode in the case that the quality of the signal received from the external electronic device is greater than or equal to (or greater than) a second value.

In operation 1104, the electronic device 100 may identify whether the number of packets that failed to be transmitted to an external electronic device is greater than or equal to a fourth value, in the case that the quality of the signal received from the external electronic device is less than (or less than or equal to) a second value (operation 1103-Y).

The electronic device 100 may identify whether the number of packets that failed to be transmitted to an external electronic device out of the packets it attempted to send is greater than or equal to (or greater than) a fourth value when the quality of the signal received from the external electronic device is less than a second value.

The electronic device 100 may determine to activate a diversity transmission mode in the case that the number of packets that failed to be transmitted to an external electronic device out of the packets it attempted to send is greater than or equal to (or greater than) a fourth value. In addition, the electronic device 100 may determine not to activate the diversity transmission mode in the case that the number of packets that failed to be transmitted to an external electronic device out of the packets it attempted to send is less than (or less than or equal to) the fourth value.

In operation 1105, the electronic device 100 may control the communication circuitry (e.g., the communication circuitry 510 of FIG. 5) to activate the diversity transmission mode in the case that the number of packets that failed to be transmitted to an external electronic device is greater than or equal to the fourth value (operation 1104-Y).

In operation 1106, the electronic device 100 may determine whether the quality of the signal received from the external electronic device is less than (or less than or equal to) a first value in the case that the estimated throughput when operating in the diversity transmission mode is less than the currently measured throughput (operation 1102-N).

According to one example, the first value and the second value may be configured differently. For example, the first value may be configured to be larger than the second value. The configuration may be to activate (or switch to) diversity transmission mode more quickly when the electronic device 100 satisfies designated conditions.

In the case that the first value is configured to be larger than the second value and a signal with a quality less than the first value but greater than the second value is received from an external electronic device, the electronic device 100 may control the communication circuitry 510 to activate the diversity transmission mode when the estimated throughput when operating in the diversity transmission mode is greater than or equal to the currently measured throughput. The electronic device 100 may not switch the communication circuitry 510 to diversity transmission mode when it receives a signal from an external electronic device having a quality less than the first value but greater than the second value, in the case that the estimated throughput when operating in diversity transmission mode is less than the currently measured throughput. That is, by configuring the value for comparison with the quality of the signal received from the external electronic device differently depending on whether the estimated throughput when operating in the diversity transmission mode is greater than or equal to the currently measured throughput, the electronic device 100 may perform the transition to the diversity transmission mode more quickly as the quality of the signal received from the external electronic device deteriorates, thereby improving the transmission performance of short-range wireless communication.

The electronic device 100 may determine whether to activate the diversity transmission mode based at least in part on the quality of the signal received from the external electronic device being less than (or less than or equal to) a first value, in the case that the estimated throughput when operating in the diversity transmission mode is less than the currently measured throughput.

The electronic device 100 may determine to not activate the diversity transmission mode in the case that the quality of the signal received from the external electronic device is greater than or equal to (or greater than) a first value.

In operation 1107, the electronic device 100 may determine whether the number of packets that failed to be transmitted to an external electronic device is greater than or equal to a third value when the quality of the signal received from the external electronic device is less than a first value (operation 1106-Y).

The third value and the fourth value may be configured differently. The third value may be configured to be smaller than the fourth value. The configuration may be to activate (or switch to) diversity transmission mode more quickly when the electronic device 100 satisfies the designated conditions.

When the third value is configured to be smaller than the fourth value, the electronic device 100 may control the communication circuitry 510 to activate the diversity transmission mode in the case that the estimated throughput when operating in the diversity transmission mode is greater than or equal to the currently measured throughput, and the number of packets that failed to be transmitted to an external electronic device is greater than a third value and less than a fourth value. The electronic device 100 may not cause the communication circuitry 510 to perform the operation of activating the diversity transmission mode in the case that the estimated throughput when operating in the diversity transmission mode is less than the currently measured throughput, and the number of packets that failed to be transmitted to an external electronic device is greater than a third value and less than a fourth value. For example, by configuring the value for comparison with the number of packets that failed to be transmitted to an external electronic device differently depending on whether the estimated throughput when operating in the diversity transmission mode is greater than or equal to the currently measured throughput, the electronic device 100 may perform the switch to the diversity transmission mode more quickly as the quality of the signal received from the external electronic device degrades, thereby improving the transmission performance of short-range wireless communication.

The electronic device 100 may determine to activate the diversity transmission mode when the number of packets that failed to be transmitted to an external electronic device out of the packets it attempted to send is greater than or equal to (or greater than) a third value. In addition, the electronic device 100 may determine not to activate the diversity transmission mode in the case that the number of packets that failed to be transmitted to an external electronic device out of the packets it attempted to send is less than (or less than or equal to) a third value.

The electronic device 100 may control the communication circuitry 510 to activate the diversity transmission mode in the case that the number of packets that failed to be transmitted to an external electronic device is greater than or equal to the third value (operation 1107-Y).

The electronic device 100 may release the fixed mode of the diversity transmission mode, in operation 1108, when the fixed mode of the diversity transmission mode is configured, in the case that the quality of the signal is not less than a second value (operation 1103-N), the quality of the signal is not less than a first value (operation 1106-N), the number of packets that failed to be transmitted is not greater than or equal to a third value (operation 1107-N), and/or the number of packets that failed to be transmitted is not greater than or equal to a fourth value (operation 1104-N).

The fixed mode of the diversity transmission mode may refer to the communication circuitry 510 maintaining the diversity transmission mode regardless of the quality of the signal received from the external electronic device.

As the electronic device 100 releases the fixed mode of the diversity transmission mode, the communication circuitry 510 may perform adjustment of the MCS level and/or switching of the signal transmission method based on the quality of the signal received from the external electronic device.

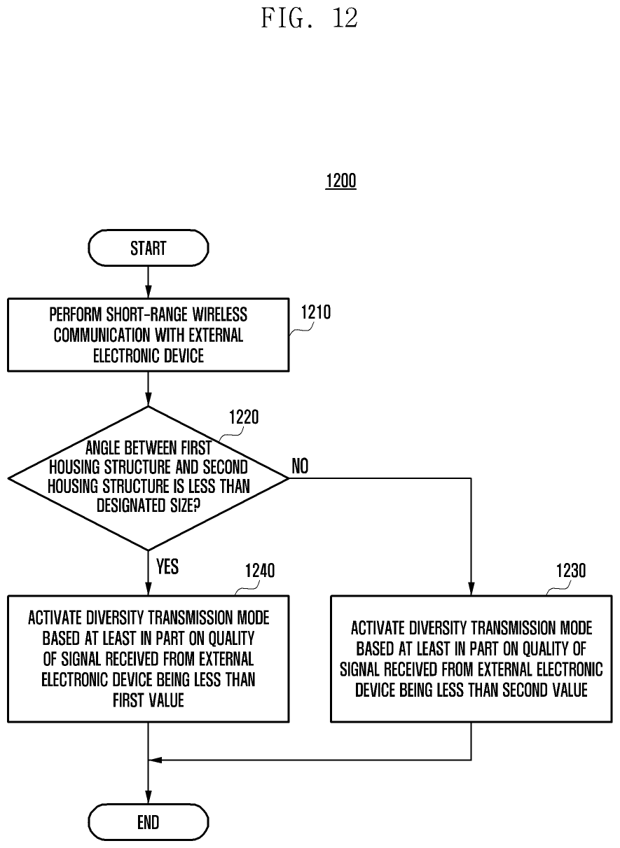

FIG. 12 is a flowchart 1200 illustrating an example method of operating an electronic device according to various embodiments.

The electronic device (e.g., the electronic device 100 of FIG. 5) may perform short-range wireless communication with an external electronic device in operation 1210.

The electronic device 100 may control the communication circuitry 510 to broadcast a probe request message to search for the external electronic device. The probe request message may include information about the electronic device 100. For example, the probe request message may include various identification information (e.g., MAC address) that distinguishes the electronic device 100 from other electronic devices and performance information related to short-range wireless communication of the electronic device 100. Upon receiving the probe request message, the external electronic device may transmit a probe response message corresponding to the probe request message to the electronic device 100. Upon receiving the probe response message, the electronic device 100 may successfully complete the discovery of the external electronic device.

Upon discovering the external electronic device, the electronic device 100 may perform an authentication procedure, an association procedure, and/or a security setup procedure with the external electronic device. Upon completion of the aforementioned procedures, the electronic device 100 may complete a connection with the external electronic device through short-range wireless communication.

The electronic device 100 may complete the connection with the external electronic device through short-range wireless communication and perform short-range wireless communication with the external electronic device. As the electronic device 100 performs short-range wireless communication with the external electronic device, it may receive signals from the external electronic device. According to one example, the signal received from the external electronic device may be a signal containing at least a portion of user data related to the performance of a service using short-range wireless communication, or it may be a signal related to the configuration of short-range wireless communication (e.g., a beacon signal).

The electronic device 100 may control the communication circuitry 510 to identify the quality of the signal received from the external electronic device at designated intervals. The electronic device 100 may perform at least one operation to control the communication circuitry 510 based on the quality of the signal received from the external electronic device.

According to an example, the electronic device 100 may determine whether to switch the signal transmission mode of the communication circuitry 510 based on the quality of the signal received from the external electronic device. For example, the electronic device 100 may determine whether the communication circuitry 510 activates a diversity transmission mode based on whether the quality of the signal received from the external electronic device is less than (or less than or equal to) a designated level.

In operation 1220, the electronic device 100 may identify whether the angle between the first housing structure (e.g., the first housing structure 210 of FIG. 2A) and the second housing structure (e.g., the second housing structure 220 of FIG. 2A) is less than a designated size.

According to an example, the electronic device 100 may configure a value for comparison with the quality of the signal received from the external electronic device differently depending on whether the angle between the first housing structure 210 and the second housing structure 220 is less than a designated size. In the case that the angle between the first housing structure 210 and the second housing structure 220 is less than (or less than or equal to) a designated size, the distance between antennas performing signal output through short-range wireless communication may decrease and the decrease in distance between antennas may cause a degradation in the performance of the short-range wireless communication.

In operation 1240, the electronic device 100 may activate the diversity transmission mode based at least in part on the quality of the signal received from the external electronic device being less than (or less than or equal to) a first value when the angle between the first housing structure 210 and the second housing structure 220 is less than a designated size (operation 1220-Y).

The electronic device 100 may determine whether to activate the diversity transmission mode based at least in part on whether the quality of the signal received from the external electronic device is less than a first value when the angle between the first housing structure 210 and the second housing structure 220 is less than (or less than or equal to) a designated size.

The electronic device 100 may determine to not activate the diversity transmission mode in the case that the quality of the signal received from the external electronic device is greater than or equal to (or greater than) a first value.

The electronic device 100 may identify whether the number of packets that failed to be transmitted to an external electronic device out of the packets it attempted to send is greater than or equal to (or greater than) a third value, in the case that the quality of the signal received from the external electronic device is less than (or less than or equal to) a first value.

The electronic device 100 may determine to activate the diversity transmission mode when the number of packets that failed to be transmitted to an external electronic device out of the packets it attempted to send is greater than or equal (or greater than) the third value. In addition, the electronic device 100 may determine not to activate the diversity transmission mode when the number of packets that failed to be transmitted to an external electronic device out of the packets it attempted to send is less than (or less than or equal to) the third value.

In operation 1230, the electronic device 100 may activate the diversity transmission mode based at least in part on the quality of the signal received from the external electronic device being less than (or less than or equal to) the second value, when the angle between the first housing structure 210 and the second housing structure 220 is greater than or equal to the designated size (operation 1220-N).

The electronic device 100 may determine whether to activate the diversity transmission mode based at least in part on the quality of the signal received from the external electronic device being less than the second value, when the angle between the first housing structure 210 and the second housing structure 220 is greater than or equal to (or greater than) a designated size.

The electronic device 100 may determine to not activate the diversity transmission mode, when the quality of the signal received from the external electronic device is greater than or equal to (or greater than) the second value.

The electronic device 100 may identify whether the number of packets that failed to be transmitted to an external electronic device out of the packets it attempted to send is greater than or equal to (or greater than) the fourth value, when the quality of the signal received from the external electronic device is less than (or less than or equal to) the second value.

The electronic device 100 may determine to activate the diversity transmission mode, when the number of packets that failed to be transmitted to an external electronic device out of the packets it attempted to send is greater than or equal to (or greater than) the fourth value. In addition, the electronic device 100 may determine not to activate the diversity transmission mode, when the number of packets that failed to be transmitted to an external electronic device out of the packets it attempted to send is less than (or less than or equal to) the fourth value.

In the case that the electronic device 100 determines to activate the diversity transmission mode, the electronic device 100 may transmit a signal requesting activation of the diversity transmission mode to the communication circuitry 510. Upon receiving the signal requesting activation of the diversity transmission mode from the electronic device 100, the communication circuitry 510 may activate the diversity transmission mode. In the case that the electronic device 100 determines to activate the diversity transmission mode, the communication circuitry 510 may maintain the activation of the diversity transmission mode regardless of the quality of the signal received from the external electronic device. For example, the communication circuitry 510 may perform MCS level adjustment based on quality of the signal, but may prohibit performing the operation of switching from diversity transmission mode to spatial multiplexing mode.

In the case that the electronic device 100 determines not to activate the diversity transmission mode, the communication circuitry 510 may perform adjustment of the MCS level and/or switching of the signal transmission method based on the quality of the signal received from the external electronic device.

According to an example, the first value and the second value may be configured differently from each other. For example, the first value may be configured to be larger than the second value. In addition, the third value and the fourth value may be configured differently from each other. The third value may be configured to be smaller than the fourth value. The configurations may be to activate (or switch to) the diversity transmission mode more quickly when the electronic device 100 satisfies designated conditions.

In the case that the first value is configured to be larger than the second value, and a signal with a quality smaller than the first value but larger than the second value is received from an external electronic device, the electronic device 100 may control the communication circuitry 510 to activate the diversity transmission mode when the angle between the first housing structure 210 and the second housing structure 220 is less than (or less than or equal to) a designated size. The electronic device 100 may not switch the communication circuitry 510 to the diversity transmission mode, as it receives a signal from the external electronic device having a quality less than the first value but greater than the second value, in the case that the angle between the first housing structure 210 and the second housing structure 220 is greater than or equal to (or greater than) a designated size. That is, by configuring a value for comparison with the quality of the signal received from the external electronic device differently depending on whether the angle between the first housing structure 210 and the second housing structure 220 is less than (or less than or equal to) a designated size, the electronic device 100 may perform the switch to the diversity transmission mode more quickly as the quality of the signal received from the external electronic device degrades, thereby improving the transmission performance of short-range wireless communication.

In the case that the third value is configured to be smaller than the fourth value, the electronic device 100 may activate (or switch to) the diversity transmission mode more quickly when the angle between the first housing structure 210 and the second housing structure 220 is less than (or less than or equal to) a designated size and the number of packets that failed to be transmitted to an external electronic device is greater than the third value and less than the fourth value, the electronic device 100 may control the communication circuitry 510 to activate the diversity transmission mode. Conversely, the electronic device 100 may not perform the operation of the communication circuitry 510 activating the diversity transmission mode when the angle between the first housing structure 210 and the second housing structure 220 is greater than or equal to a designated size, and the number of packets that failed to be transmitted to an external electronic device is greater than a third value and less than a fourth value. For example, by configuring the value for comparison with the number of packets that failed to be transmitted to an external electronic device differently depending on whether the angle between the first housing structure 210 and the second housing structure 220 is less than a designated size, the electronic device 100 may perform the switch to the diversity transmission mode more quickly as the quality of the signal received from the external electronic device degrades, thereby improving the transmission performance of short-range wireless communication.

An electronic device (e.g., the electronic device 100 of FIG. 5) according to an example embodiment may include a housing comprising a first housing structure (e.g., the first housing structure 210 of FIG. 6) and a second housing structure (e.g., the second housing structure 220 of FIG. 6) foldable or movable with respect to each other. The electronic device 100 may include a plurality of antennas. The electronic device 100 may include a communication circuitry (e.g., the communication circuitry 510 of FIG. 5) supporting short-range wireless communication. The electronic device 100 may include a memory (e.g., the memory 530 of FIG. 5) storing at least one computer program containing instructions. The electronic device 100 may include at least one processor (e.g., the processor 520 of FIG. 5). The instructions, when executed individually or collectively by the at least one processor 520, may cause the electronic device 100 to perform short-range wireless communication with an external electronic device. The instructions, when executed individually or collectively by the at least one processor 520, may cause the electronic device 100 to, when the angle between the first housing structure 210 and the second housing structure 220 is less than a designated size, control the communication circuitry 510 to activate a diversity transmission mode that outputs signals containing the same data through each of the plural antennas, based at least in part on the quality of the signal received from the external electronic device being less than or equal to a first value. The instructions, when executed individually or collectively by the at least one processor 520, may cause the electronic device to, when the angle between the first housing structure 210 and the second housing structure 220 is greater than or equal to a designated size, control the communication circuitry 510 to activate the diversity transmission mode based at least in part on the quality of the signal received from the external electronic device being less than a second value. The first value may be configured to be greater than the second value.

In the electronic device 100 according to an example, when the instructions are individually or collectively executed by the at least one processor 520, the electronic device 100 may identify the quality of a signal from the external electronic device while the angle between the first housing structure 210 and the second housing structure 220 is greater than or equal to the designated size. The instructions, when executed individually or collectively by the at least one processor 520, may prevent or inhibit the electronic device 100 from transmitting a signal for requesting activation of the diversity transmission mode to the communication circuitry 510 based at least in part on the quality being less than the first value and greater than the second value. The instructions, when executed individually or collectively by the at least one processor 520, may cause the electronic device 100 to transmit a signal for requesting activation of the diversity transmission mode to the communication circuitry 510 as it detects that the angle between the first housing structure 210 and the second housing structure 220 is less than the designated size.

In the electronic device 100 according to an example, when the instructions are individually or collectively executed by the at least one processor 520, the electronic device 100 may identify the quality of a signal from the external electronic device while the angle between the first housing structure 210 and the second housing structure 220 is less than the designated size. The instructions, when executed individually or collectively by the at least one processor 520, may control the communication circuitry 510 to activate the diversity transmission mode based at least in part on the quality being less than the first value and greater than the second value. The instructions, when executed individually or collectively by the at least one processor 520, may control the communication circuitry 510 to deactivate the diversity transmission mode as the electronic device 100 detects that the angle between the first housing structure 210 and the second housing structure 220 is greater than or equal to the designated size.

In the electronic device 100 according to an example, when the instructions are individually or collectively executed by the at least one processor 520, the electronic device 100 may identify the number of packets that failed to be transmitted to the external electronic device when the quality of the signal received from the external electronic device is less than the first value while the angle between the first housing structure 210 and the second housing structure 220 is less than a designated size. The instructions may cause the electronic device 100 to control the communication circuitry 510 to activate the diversity transmission mode based on the number of the packets being greater than or equal to a third value when executed individually or collectively by the at least one processor 520. The instructions, when executed individually or collectively by the at least one processor 520, may cause the electronic device 100 to identify the number of packets that failed to be transmitted to the external electronic device when the quality of the signal received from the external electronic device is less than the second value in a state in which the angle between the first housing structure 210 and the second housing structure 220 is greater than or equal to a designated size. The instructions, when executed individually or collectively by the at least one processor 520, may control the electronic device 100 to activate the diversity transmission mode based on the number of the packets being equal to or greater than the fourth value. The third value may be configured to be less than the fourth value.

In the electronic device 100 according to an example, when instructions are individually or collectively executed by the at least one processor 520, the electronic device 100 may cause the communication circuitry 510 to prohibit switching between the diversity transmission mode and the spatial multiplexing mode in which each of the plurality of antennas outputs signals containing different data based on the quality received from the external electronic device, when the at least one processor 520 controls the communication circuitry 510 to activate the diversity transmission mode,

According to an example embodiment, in a non-transitory computer-readable recording medium storing at least one program comprising instructions that when executed by at least one processor, comprising processing circuitry, of the electronic device, individually or collectively, cause the electronic device 100 to perform short-range wireless communication with an external electronic device. When executed individually or collectively by the at least one processor 520, the instructions may cause the electronic device 100 to, when the angle between a first housing structure 210 of the electronic device 100 and a second housing structure 220 of the electronic device 100 is less than a designated size, control the communication circuitry 510 to activate a diversity transmission mode that outputs signals containing the same data through each of the plural antennas, based at least in part on the quality of the signal received from the external electronic device being less than a first value. When executed individually or collectively by the at least one processor 520, the instructions may cause the electronic device to, when the angle between the first housing structure 210 and the second housing structure 220 is greater than or equal to a designated size, control the communication circuitry 510 to activate the diversity transmission mode based at least in part on the quality of the signal received from the external electronic device being less than a second value. The first value may be configured to be greater than the second value.

In the recording medium according to an example, the instructions, when executed individually or collectively by the at least one processor 520, may cause the electronic device 100 to identify the quality of a signal from the external electronic device while the angle between the first housing structure 210 and the second housing structure 220 is greater than or equal to the designated size. The instructions, when executed individually or collectively by the at least one processor 520, may prevent or inhibit the electronic device 100 from transmitting a signal for requesting activation of the diversity transmission mode to the communication circuitry 510 based at least in part on the quality being less than the first value and greater than the second value. The instructions, when executed individually or collectively by the at least one processor 520, may cause the electronic device 100 to transmit a signal for requesting activation of the diversity transmission mode to the communication circuitry 510 as it detects that the angle between the first housing structure 210 and the second housing structure 220 is less than the designated size.

In the recording medium according to an example, the instructions, when executed individually or collectively by the at least one processor 520, may cause the electronic device 100 to identify the quality of a signal from the external electronic device while the angle between the first housing structure 210 and the second housing structure 220 is less than the designated size. The instructions, when executed individually or collectively by the at least one processor 520, may control the communication circuitry 510 to activate the diversity transmission mode based at least in part on the quality being less than the first value and greater than the second value. The instructions, when executed individually or collectively by the at least one processor 520, may control the communication circuitry 510 to deactivate the diversity transmission mode as the electronic device 100 detects that the angle between the first housing structure 210 and the second housing structure 220 is greater than or equal to the designated size.

In the recording medium according to an example, the instructions, when executed individually or collectively by the at least one processor 520, may cause the electronic device 100 to identify the number of packets that failed to be transmitted to the external electronic device when the quality of the signal received from the external electronic device is less than the first value while the angle between the first housing structure 210 and the second housing structure 220 is less than a designated size. The instructions, when executed individually or collectively by the at least one processor 520, the electronic device 100 may control the communication circuitry 510 to activate the diversity transmission mode based on the number of the packets being greater than or equal to a third value. The instructions, when executed individually or collectively by the at least one processor 520, may allow the electronic device 100 to identify the number of packets that failed to be transmitted to the external electronic device when the quality of the signal received from the external electronic device is less than the second value while the angle between the first housing structure 210 and the second housing structure 220 is greater than or equal to a designated size. The instructions, when executed individually or collectively by the at least one processor 520, may control the electronic device 100 to activate the diversity transmission mode based on the number of the packets being equal to or greater than the fourth value. The third value may be configured to be less than the fourth value.

In the recording medium according to an example, when instructions are individually or collectively executed by the at least one processor 520, the electronic device 100 may cause the communication circuitry 510 to prohibit switching between the diversity transmission mode and the spatial multiplexing mode in which each of the plurality of antennas outputs signals containing different data based on the quality received from the external electronic device, when the at least one processor 520 controls the communication circuitry 510 to activate the diversity transmission mode.

According to an example embodiment, a method of operating an electronic device 100 comprising a housing including a first housing structure 210 and a second housing structure 220 foldable or movable with respect to each other may include performing short-range wireless communication with an external electronic device. The method of operating the electronic device 100 may include, when the angle between a first housing structure 210 and a second housing structure 220 is less than a designated size, controlling the communication circuitry 510 of the electronic device 100 to activate a diversity transmission mode that outputs signals containing the same data through each of the plural antennas, based at least in part on the quality of the signal received from the external electronic device being less than a first value. The method of operating the electronic device 100 may include, when the angle between the first housing structure and the second housing structure is greater than or equal to a designated size, controlling the communication circuitry 510 to activate the diversity transmission mode, based at least in part on the quality of the signal received from the external electronic device being less than a second value. The first value may be configured to be greater than the second value.

The method of operating the electronic device 100 according to an example may further include an operation of identifying the quality of a signal from the external electronic device while the angle between the first housing structure 210 and the second housing structure 220 is greater than or equal to the designated size. The method of operating the electronic device 100 may further include an operation of prohibiting transmitting a signal requesting activation of the diversity transmission mode to the communication circuitry 510, based at least in part on the quality being less than the first value and greater than the second value. The method of operating the electronic device 100 may further include an operation of transmitting a signal requesting activation of the diversity transmission mode to the communication circuitry 510, as it detects that the angle between the first housing structure 210 and the second housing structure 220 is less than the designated size.

The method of operating the electronic device 100 according to an example may further include an operation of identifying the quality of a signal from the external electronic device while an angle between the first housing structure 210 and the second housing structure 220 is less than the designated size. The method of operating the electronic device 100 may further include an operation of controlling the communication circuitry 510 to activate the diversity transmission mode based at least in part on the quality being less than the first value and greater than the second value. The method of operating the electronic device 100 may further include an operation of controlling the communication circuitry 510 to deactivate the diversity transmission mode as it detects that the angle between the first housing structure 210 and the second housing structure 220 is greater than or equal to the designated size.

The method of operating the electronic device 100 according to an example may further include an operation of identifying the number of packets that failed to be transmitted to the external electronic device when the quality of the signal received from the external electronic device is less than the first value while the angle between the first housing structure 210 and the second housing structure 220 is less than a designated size. The method of operating the electronic device 100 may further include an operation of controlling the communication circuitry 510 to activate the diversity transmission mode based on the number of packets being greater than or equal to the third value. The method of operating the electronic device 100 may further include an operation of identifying the number of packets that failed to be transmitted to the external electronic device when the quality of the signal received from the external electronic device is less than the second value while the angle between the first housing structure 210 and the second housing structure 220 is greater than or equal to a designated size. The method of operating the electronic device 100 may further include an operation of controlling the communication circuitry 510 to activate the diversity transmission mode based on the number of the packets being greater than or equal to the fourth value. The third value may be configured to be less than the fourth value.

The method of operating the electronic device 100 according to an example may further include an operation of prohibiting the communication circuitry 510 to switch between the diversity transmission mode and the spatial multiplexing mode in which each of the plurality of antennas outputs signals including different data based on the quality received from the external electronic device when at least one processor 520 of the electronic device 100 controls the communication circuitry 510 to activate the diversity transmission mode.

The electronic device 100 according to an example embodiment may include a plurality of antennas. The electronic device 100 may include a communication circuitry 510 that supports short-range wireless communication. The electronic device 100 may further include a memory 530 that stores at least one computer program including instructions. The electronic device 100 may include at least one processor 520. The instructions may cause the electronic device 100 to perform short-range wireless communication with an external electronic device when executed individually or collectively by the at least one processor 520. The instructions, when executed individually or collectively by the at least one processor 520, may control the communication circuitry 510 to activate a diversity transmission mode in which signals including the same data are output through each of the plurality of antennas based at least in part on the quality of a signal received from the external electronic device 100 when the electronic device 100 satisfies designated conditions. The instructions, when executed individually or collectively by the at least one processor 520, may control the communication circuitry 510 to activate the diversity transmission mode based on at least part of the quality of a signal received from an external electronic device is less than the second value. The first value may be configured to be greater than the second value.

In the electronic device 100 according to an example 352, the designated condition may include a condition in which the electronic device 100 activates a mode (Tx backoff mode) for reducing the output of a signal to be transmitted, a condition in which the electronic device 100 and the external electronic device are not in a line of sight (LoS) and/or a condition in which the electronic device 100 performs a designated service.

In the electronic device 100 according to an example, the instructions, when executed individually or collectively by the at least one processor 520, may cause the electronic device 100 to identify the quality of a signal from the external electronic device while the electronic device 100 does not satisfy the designated condition. The instructions, when executed individually or collectively by the at least one processor 520, may prevent or inhibit the electronic device 100 from transmitting a signal for requesting activation of the diversity transmission mode to the communication circuitry 510 based at least in part on the quality being less than the first value and greater than the second value. The instructions, when executed individually or collectively by the at least one processor 520, may cause the electronic device 100 to transmit a signal for requesting activation of the diversity transmission mode to the communication circuitry 510.

In the electronic device 100 according to an example, the instructions, when executed individually or collectively by the at least one processor 520, may cause the electronic device 100 to identify the quality of a signal from the external electronic device while the electronic device 100 satisfies the designated condition. The instructions, when executed individually or collectively by the at least one processor 520, may control the communication circuitry 510 to activate the diversity transmission mode based at least in part on the quality being less than the first value and greater than the second value. The instructions, when executed individually or collectively by the at least one processor 520, may control the communication circuitry 510 to deactivate the diversity transmission mode as the electronic device 100 is switched to a state that does not satisfy the designated condition.

In the electronic device 100 according to an example, when instructions are individually or collectively executed by the at least one processor 520, the electronic device 100 may cause the communication circuitry 510 to prohibit switching between the diversity transmission mode and the spatial multiplexing mode in which each of the plurality of antennas outputs signals containing different data based on the quality received from the external electronic device, when the at least one processor 520 controls the communication circuitry 510 to activate the diversity transmission mode.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a housing including a first housing structure and a second housing structure foldable or movable with respect to each other;
a plurality of antennas;
communication circuitry configured to support short-range wireless communication;
a memory storing at least one computer program containing instructions; and
at least one processor, comprising processing circuitry,
wherein the instructions, when executed individually or collectively by the at least one processor, cause the electronic device to:
perform short-range wireless communication with an external electronic device;
control the communication circuitry to activate a diversity transmission mode that the electronic device outputs signals containing the same data through each of the plural antennas based at least in part on a quality of the signal received from the external electronic device being less than or equal to a first value, when the angle between the first housing structure and the second housing structure is less than a designated size; and
control the communication circuitry to activate the diversity transmission mode based at least in part on the quality of the signal received from the external electronic device being less than a second value, when the angle between the first housing structure and the second housing structure is greater than or equal to a designated size, and
wherein the first value is greater than the second value.

2. The electronic device of claim 1, wherein the instructions, when executed individually or collectively by the at least one processor, cause the electronic device to:
identify the quality of the signal received from the external electronic device, while the angle between the first housing structure and the second housing structure is greater than or equal to the designated value;
refrain from transmitting a signal for requesting activation of the diversity transmission mode to the communication circuitry based at least in part on the quality being less than the first value and greater than the second value; and
transmit the signal for requesting activation of the diversity transmission mode to the communication circuitry, based on detecting that the angle between the first housing structure and the second housing structure is less than the designated value.

3. The electronic device of claim 1, wherein the instructions, when executed individually or collectively by the at least one processor, cause the electronic device to:
identify the quality of the signal received from the external electronic device, while the angle between the first housing structure and the second housing structure is less than the designated value;
control the communication circuitry to activate the diversity transmission mode based at least in part on the quality being less than the first value and greater than the second value, and
control the communication circuitry to deactivate the diversity transmission mode, based on detecting that the angle between the first housing structure and the second housing structure is greater than or equal to the designated value.

4. The electronic device of claim 1, wherein the instructions, when executed individually or collectively by the at least one processor, cause the electronic device to:
identify the number of packets that failed to be transmitted to an external electronic device based on the quality of the signal received from the external electronic device being less than the first value, while the angle between the first housing structure and the second housing structure is less than the designated value;
control the communication circuitry to activate the diversity transmission mode based on the number of packets being greater than or equal to the third value;
identify the number of packets that failed to be transmitted to an external electronic device based on the quality of the signal received from the external electronic device being less than the second value, in a state that the angle between the first housing structure and the second housing structure is greater than or equal to the designated size; and
control the communication circuitry to activate the diversity transmission mode based on the number of packets being greater than or equal to the fourth value, and
wherein the third value is less than the fourth value.

5. The electronic device of claim 1, wherein the instructions, when executed individually or collectively by the at least one processor, cause the electronic device to refrain from switching, by the communication circuitry, between the diversity transmission mode and a spatial multiplexing mode in which each of the plurality of antennas is configured to output signals containing different data based on the quality received from the external electronic device, when the at least one processor controls the communication circuitry to activate the diversity transmission mode.

6. A non-transitory computer-readable recording medium storing at least one program comprising instructions that cause the electronic device to perform operations when executed individually or collectively by at least one processor of the electronic device,
wherein the instructions, when executed individually or collectively by the at least one processor, cause the electronic device to:
perform short-range wireless communication with an external electronic device;
control the communication circuitry to activate a diversity transmission mode configured to output signals containing the same data through each of the plural antennas, based at least in part on the quality of the signal received from the external electronic device being less than a first value, when the angle between a first housing structure of the electronic device and a second housing structure of the electronic device is less than a designated size; and
control the communication circuitry to activate a diversity transmission mode, when the angle between the first housing structure and the second housing structure is greater than or equal to a designated size, based at least in part on the quality of the signal received from the external electronic device being less than a second value, and
wherein the first value is greater than the second value.

7. The non-transitory computer-readable recording medium of claim 6, wherein the instructions, when executed individually or collectively by at least one processor, cause the electronic device to:
identify the quality of the signal from the external electronic device, while the first housing structure and the second housing structure is greater than or equal to the designated size;
refrain from transmitting the signal requesting activation of the diversity transmission mode from being transmitted to the communication circuitry, based at least in part on the quality being less than the first value and greater than the second value; and
transmit a signal requesting activation of the diversity transmission mode to the communication circuitry, based on detecting that the angle between the first housing structure and the second housing structure is less than the designated size.

8. The non-transitory computer-readable recording medium of claim 6, wherein the instructions, when executed individually or collectively by the at least one processor, cause the electronic device to:
identify the quality of the signal received from the external electronic device, while the angle between the first housing structure and the second housing structure is less than the designated value;
control the communication circuitry to activate the diversity transmission mode based at least in part on the quality being less than the first value and greater than the second value, and
control the communication circuitry to deactivate the diversity transmission mode, based on detecting that the angle between the first housing structure and the second housing structure is greater than or equal to the designated value.

9. The non-transitory computer-readable recording medium of claim 6, wherein the instructions, when executed individually or collectively by the at least one processor, cause the electronic device to:
identify the number of packets that failed to be transmitted to an external electronic device in the case that the quality of the signal received from the external electronic device is less than the first value, while the angle between the first housing structure and the second housing structure is less than the designated value;
control the communication circuitry to activate the diversity transmission mode based on the number of packets being greater than or equal to the third value;
identify the number of packets that failed to be transmitted to an external electronic device in the case that the quality of the signal received from the external electronic device is less than the second value, while the angle between the first housing structure and the second housing structure is greater than or equal to the designated size; and
control the communication circuitry to activate the diversity transmission mode based on the number of packets is greater than or equal to the fourth value, and
wherein the third value is less than the fourth value.

10. The non-transitory computer-readable recording medium of claim 6, wherein
the instructions, when executed individually or collectively by the at least one processor, cause the electronic device to refrain from switching, by the communication circuitry, between the diversity transmission mode and the spatial multiplexing mode in which each of the plurality of antennas outputs signals containing different data based on the quality received from the external electronic device, when the at least one processor controls the communication circuitry to activate the diversity transmission mode.

11. A method of operating an electronic device comprising a housing including a first housing structure and a second housing structure foldable or movable with respect to each other, the method comprising:
performing short-range wireless communication with an external electronic device;
controlling communication circuitry of the electronic device to activate a diversity transmission mode that outputs signals containing the same data through each of the plurality of antennas, in the case that the angle between the first housing structure and the second housing structure is less than the designated size, based at least in part on the quality of the signal received from the external electronic device being less than the first value; and
controlling the communication circuitry to activate the diversity transmission mode, in the case that the angle between the first housing structure and the second housing structure is greater than the designated size, based at least in part on the quality of the signal received from the external electronic device being less than the second value, and
wherein the first value is greater than the second value.

12. The method of claim 11, further comprising:
identifying the quality of the signal from the external electronic device, while the first housing structure and the second housing structure is greater than or equal to the designated size;
refraining from transmitting the signal requesting activation of the diversity transmission mode to the communication circuitry, based at least in part on the quality being less than the first value and greater than the second value; and
transmitting a signal requesting activation of the diversity transmission mode to the communication circuitry, based on detecting that the angle between the first housing structure and the second housing structure is less than the designated size.

13. The method of claim 11, further comprising:
identifying the quality of the signal received from the external electronic device, while the angle between the first housing structure and the second housing structure is less than the designated value;
controlling the communication circuitry to activate the diversity transmission mode based at least in part on the quality being less than the first value and greater than the second value, and
controlling the communication circuitry to deactivate the diversity transmission mode, based on detecting that the angle between the first housing structure and the second housing structure is greater than or equal to the designated value.

14. The method of claim 11, further comprising:
identifying the number of packets that failed to be transmitted to an external electronic device in the case that the quality of the signal received from the external electronic device is less than the first value, while the angle between the first housing structure and the second housing structure is less than the designated value;
controlling the communication circuitry to activate the diversity transmission mode based on the number of packets being greater than or equal to the third value;
identifying the number of packets that failed to be transmitted to an external electronic device in the case that the quality of the signal received from the external electronic device is less than the second value, while the angle between the first housing structure and the second housing structure is greater than or equal to the designated size; and
controlling the communication circuitry to activate the diversity transmission mode based on the number of packets is greater than or equal to the fourth value, and
wherein the third value is less than the fourth value.

15. The method of claim 11, further comprising:
refraining from switching, by the communication circuitry, between the diversity transmission mode and the spatial multiplexing mode in which each of the plurality of antennas outputs signals containing different data based on the quality received from the external electronic device, when the at least one processor controls the communication circuitry to activate the diversity transmission mode.

16. An electronic device comprising:
a plurality of antennas;
communication circuitry configured to support short-range wireless communication;
a memory storing at least one computer program containing instructions; and
at least one processor, comprising processing circuitry, wherein:
at least one processor, individually and/or collectively, is configured to execute the instructions and to cause the electronic device to:
perform short-range wireless communication with an external electronic device;
control the communication circuitry to activate a diversity transmission mode configured to output signals containing the same data through each of the plural antennas based at least in part on a quality of the signal received from the external electronic device being less than or equal to a first value, based on the electronic device satisfying a designated condition; and
control the communication circuitry to activate the diversity transmission mode based at least in part on the quality of the signal received from the external electronic device being less than a second value, based on the electronic device not satisfying the designated condition, and
wherein the first value is greater than the second value.

17. The electronic device of claim 16, wherein
the designated conditions comprise a condition of activating a Tx backoff mode configured to reduce the signal to be transmitted, a condition of a distance between the electronic device and the external electronic device not being in line of sight (LoS), and/or a condition of the electronic device performing the designated service.

18. The electronic device of claim 16, wherein:
at least one processor, individually and/or collectively, is configured to cause the electronic device to:
identify the quality of the signal from the external electronic device, while the electronic device does not satisfy the designated condition;
inhibit the signal requesting activation of the diversity transmission mode from being transmitted to the communication circuitry, based at least in part on the quality being less than the first value and greater than the second value; and
transmit a signal requesting activation of the diversity transmission mode to the communication circuitry, based on the electronic device switching to a state of satisfying the designated condition.

19. The electronic device of claim 16, wherein
at least one processor, individually and/or collectively, is configured to cause the electronic device to:
identify the quality of the signal from the external electronic device, while the electronic device satisfies the designated condition;
control the communication circuitry to activate the diversity transmission mode, based at least in part on the quality being less than the first value and greater than the second value; and
control the communication circuitry to deactivate the diversity transmission mode, based on the electronic device transitioning to a state where the electronic device does not satisfy the designated condition.

20. The electronic device of claim 16, wherein:
at least one processor, individually and/or collectively, is configured to cause the electronic device to prohibit the communication circuitry switching between the diversity transmission mode and a spatial multiplexing mode in which each of the plurality of antennas is configured to output signals containing different data based on the quality received from the external electronic device, based on at least one processor, individually and/or collectively, being configure to control the communication circuitry to activate the diversity transmission mode.
